(19) United States
(12) Patent Application Publication
(10) Pub. No.: US 2020/0329052 A1
(43) Pub. Date: Oct. 15, 2020

(54) SYSTEM AND METHOD FOR ALIGNING A PACKET COUNTER IN SHORT-RANGE WIRELESS COMMUNICATIONS SYSTEMS

(71) Applicant: QUALCOMM Incorporated, San Diego, CA (US)

(72) Inventors: Giriraj GOYAL, Bangalore (IN); Vishal AGARWAL, Ramnagar (IN); Nitin Raghavendra KIDIYOOR, Bangalore (IN)

(21) Appl. No.: 16/383,259

(22) Filed: Apr. 12, 2019

(51) Int. Cl. H04L 29/06; H04W 12/00; H04L 1/00; H04W 4/80; H04L 9/06; H04L 9/32

(52) U.S. Cl. CPC H04L 63/123; H04W 12/0013; H04L 9/3242; H04W 4/80; H04L 9/0631; H04L 1/0061

(57) ABSTRACT

In an aspect of the disclosure, a method, a computer-readable medium, and an apparatus are provided. The apparatus may be a first device. The first device may decrypt a first packet using a first nonce associated with a first expected packet number. The first device may determine a next nonce based on the decryption of the first packet, wherein the next nonce is different when the first packet is unsuccessfully decrypted than when the first packet is successfully decrypted. The first device may decrypt a second packet received consecutive to the first packet based on the next nonce.

### TECHNICAL FIELD

The present disclosure relates generally to communication systems, and more particularly, to aligning a packet counter for decrypting packets received over a short-range wireless communications network.

### DESCRIPTION OF THE RELATED TECHNOLOGY

A wireless personal area network (WPAN) is a personal, short-range wireless network for interconnecting devices centered around a specific distance from a user. WPANs have gained popularity because of the flexibility and convenience in connectivity that WPANs provide. WPANs, such as those based on short-range wireless communications protocols, provide wireless connectivity to devices by providing wireless links that allow connectivity within a specific distance, such as 5 meters, 10 meter, 20 meters, 100 meters, etc.

Short-range wireless communications protocols may include the Bluetooth® (BT) protocol, the Bluetooth® Low Energy (BLE) protocol, the Zigbee® protocol, and so forth. BT is a wireless technology standard that enables radio frequency communication with ultra-high frequency (UHF) radio waves in the globally accepted Industrial, Scientific & Medical (ISM) band, such as from 2.400 gigahertz (GHz) to 2.485 GHz. Similarly, BLE defines a standard that enables radio frequency communication operating within the 2.4 GHz ISM band.

A short-range wireless communications protocol may be used to connect devices over a WPAN. Examples of devices that may communicate over a WPAN may include laptop computers, tablet computers, smart phones, personal data assistants, audio systems such as headsets, headphones, speakers, etc., wearable devices such as smart watches, fitness trackers, etc., battery-operated sensors and actuators in various medical, industrial, consumer, and fitness applications, and so forth.

In some scenarios, WPANs may offer advantages and conveniences over other network types, such as a wireless local area network (WLAN). However, short-range wireless communications in a WPAN may be susceptible to the same or similar issues as communication in other wireless networks. For example, short-range wireless communications may experience errors due to noisy and/or congested transmission mediums. Such issues experienced with short-range wireless communications may degrade the performance of devices, may degrade a user experience, and so forth. Thus, a need exists for an approach for addressing one or more missed packets in short-range wireless communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Various standards and protocols for use with a wireless personal area network (WPAN), such as the Bluetooth® (BT) and/or Bluetooth® Low Energy (BLE), may provide for decoding and/or decryption techniques, for example, in order to ensure packet integrity, recover from missed packets, and so forth. For example, at least a portion of a packet, such as the payload of the packet, may be protected with a cyclic redundancy check (CRC) value that must match a value calculated by a receiving device in order for the packet to be successfully decoded. If the packet is encrypted, at least a portion of the packet, such as the payload, may be protected with a packet integrity code (MIC). Similar to CRC validation, a MIC must match a value calculated by the receiving device in order for the packet to be successfully decrypted. If the CRC validation and/or the MIC validation fails at the receiving device, then the packet may be invalid.

In some BT/BLE links, a packet may be encrypted using a nonce, which may be a key, a number, and/or value according to which a packet is encrypted. A transmitting device may encrypt each packet using a respective nonce that is unique to at least a portion of each packet. Correspondingly, a receiving device may decrypt each packet using a nonce that is unique to the at least the portion of each packet. Thus, a nonce used for encrypting a packet by the transmitting device should be the same as a nonce used for decrypting the packet by the receiving device. However, the nonce should not be sent over the BT/BLE link and, therefore, the transmitting and receiving devices may individually determine the same nonce for both encrypting and decrypting a packet.

One approach to obtaining the same nonce for encryption and decryption of a packet may be based on a packet number. Both the transmitting device and the receiving device may maintain a respective packet counter for packet numbers. The transmitting device may increment the packet counter of the transmitting device after each packet is encrypted, and the receiving device may increment the packet counter of the receiving device after each received packet. In this way, the transmitting device and the receiving device may maintain alignment between their respective packet counters.

When nonces are based on a packet number, the nonce at the transmitting device will match the nonce at the receiving device when the packet counters are aligned between the transmitting device and the receiving device. However, the receiving device may miss a first packet but receive a next packet. Because the receiving device may be unaware that the first packet is missed, the receiving device may attempt to decrypt the next packet with the nonce for the first packet. Decrypting the next packet with the nonce for the first packet may cause the next packet to fail MIC validation.

A receiving device may be able to transmit negative acknowledgement feedback to the transmitting device, causing the transmitting device to retransmit the first and/or next packet and allowing the receiving device to realign its own packet counter with the packet counter of the transmitting device. However, receiving devices that passively monitor for packets and/or that lack an acknowledgement mechanism to inform the transmitting device of a missed packet be unable to recover from one or more missed packets in a timely and/or convenient manner.

An example of such a receiving device may include a “secondary” earpiece of a wireless headset, such as an earbud or another individual component of a wireless headset. A transmitting device, such as a smartphone, may establish a short-range wireless communications link with a “primary” earpiece of the wireless headset, and packets transmitted to the wireless headset may be addressed to and acknowledged by the primary earpiece. The secondary earpiece passively monitors for packets transmitted to the primary earpiece. If the secondary earpiece misses a packet, then the packet counter maintained by the secondary earpiece may become unaligned with the packet counter maintained by the transmitting device. Consequently, the secondary earpiece may attempt to decrypt a packet with a nonce for a different packet, which may cause MIC validation of the packet to fail.

Nonces and other sensitive information upon which nonces are based, such as packet numbers, may not be transmitted over short-range wireless communications links, for example, in order to prevent malicious attacks, exposure of sensitive data, etc. Thus, a need exists for a mechanism to allow a receiving device, such as a receiving device that passively monitors for packets, to recover from a missed packet and maintain packet counter misalignment. With such a mechanism for maintaining packet counter alignment, incorrectly decrypted packets may be recovered, overhead incurred due to synchronization and/or relay of missed packets may be reduced, and/or offline MIC recovery may be reduced. Further, scenarios in which a short-range wireless communications link is to be reestablished in order to realign respective packet counters may be avoided.

In an aspect of the disclosure, a method, a computer-readable medium, and an apparatus are provided. The apparatus may be a first device. The first device may decrypt a first packet using a first nonce associated with a first expected packet number. The first device may determine a next nonce based on the decryption of the first packet, wherein the next nonce is different when the first packet is unsuccessfully decrypted than when the first packet is successfully decrypted. The first device may decrypt a second packet received consecutive to the first packet based on the next nonce.

In one aspect, the next nonce is associated with a second expected packet number that is consecutive to the first expected packet number when the first packet is successfully decrypted and the second expected packet number is nonconsecutive to the first expected packet number when the first packet is unsuccessfully decrypted.

In one aspect, the first device may determine to use the first nonce instead of a second nonce based on a first expected sequence number associated with the first nonce, wherein the first expected sequence number matches a first sequence number included in the first packet, and wherein the second nonce is associated with a second expected packet number.

In one aspect, the determination of the next nonce based on the decrypting of the first packet comprises to determine a next expected sequence number based on a first sequence number included in the first packet, wherein the next nonce is determined further based on the next expected sequence number.

In one aspect, the first device may validate a first MIC included in the first packet after the first packet is decrypted, wherein the first packet is successfully decrypted when the first MIC is valid, and wherein the first packet is unsuccessfully decrypted when the first MIC is invalid.

In one aspect, the first device may compare, when the first packet is unsuccessfully decrypted, a first set of octets associated with at least one of a first CRC value or a first MIC included in the first packet with a stored set of octets associated with at least one of a previous CRC value or a previous MIC included in a previous packet that is associated with a previous packet number consecutively before the first expected packet number, wherein the determination of the next nonce is further based on the comparison of the first set of octets to the stored set of octets.

In one aspect, the next nonce is associated with the first expected packet number when the first set of octets matches the stored set of octets.

In one aspect, the first device may passively monitor a short-range wireless communications link for packets transmitted by a second device. The first device may receive the first packet from the second device based on the passive monitoring of the short-range wireless communications link. The first device may receive the second packet from the second device based on the passive monitoring of the short-range wireless communications link.

In one aspect, the first device may maintain a packet counter set to an expected packet number associated with a nonce for decryption of an expected packet, wherein the packet counter is consecutively incremented to the expected packet number based on each successfully decrypted packet received from the second device over the short-range wireless communications link.

In one aspect, the decryption of the first packet is based on an Advanced Encryption

Standard (AES) with cipher block chaining message authentication code (CBC-MAC) (CCM) (AES-CCM) mode.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a short-range wireless communications system, in accordance with certain aspects of the disclosure.

FIG. 2 is block diagram of a short-range wireless communications device, in accordance with certain aspects of the disclosure.

FIG. 3A is a diagram illustrating a Bluetooth (BT) protocol stack that may be implemented by a BT device, in accordance with certain aspects of the disclosure.

FIG. 3B is a diagram illustrating a BT Low Energy (BLE) protocol stack that may be implemented by a BLE device, in accordance with certain aspects of the disclosure.

FIG. 4A is a diagram illustrating a BT data packet, in accordance with certain aspects of the disclosure.

FIG. 4B is a diagram illustrating a BLE data packet, in accordance with certain aspects of the disclosure.

FIG. 5 is a diagram illustrating a short-range wireless communications system, in accordance with certain aspects of the disclosure.

FIG. 6 is a flowchart of a method of wireless communication, in accordance with certain aspects of the disclosure.

FIGS. 7A and 7B are a flowchart of a method of aligning packet counters in a short-range wireless communications system, in accordance with certain aspects of the disclosure.

FIG. 8 is a conceptual data flow diagram illustrating the data flow between different means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

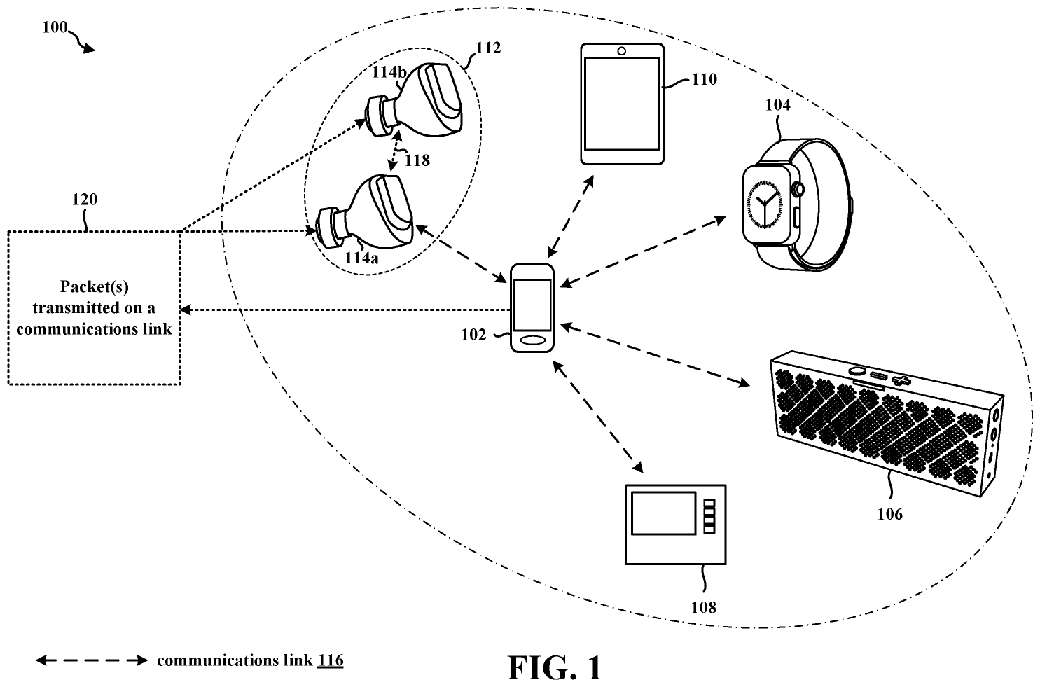

FIG. 1 illustrates an example WPAN 100 in accordance with certain aspects of the disclosure. Within the WPAN 100, a wireless device 102 may use a communications link 116 to communicate with one or more peripheral devices 104, 106, 108, 110, 112 using a short-range wireless communications protocol. The short-range wireless communications protocol may include a Bluetooth® (BT) protocol or a BT Low Energy (BLE) protocol.

Examples of the wireless device 102 include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device, a vehicle, an electric meter, a gas pump, a toaster, a thermostat, a hearing aid, a wireless headset, a blood glucose on-body unit, an Internet-of-Things (IoT) device, or any other similarly functioning device.

Examples of the one or more peripheral devices 104, 106, 108, 110, 112 include a cellular phone, a smart phone, a SIP phone, a STA, a laptop, a PC, a desktop computer, a PDA, a satellite radio, a global positioning system, a multimedia device, a video device, a digital audio player, a camera, a game console, a tablet, a smart device, a wearable device, a vehicle, an electric meter, a gas pump, a toaster, a thermostat, a hearing aid, a wireless headset, a blood glucose on-body unit, an IoT device, or any other similarly functioning device. Although the wireless device 102 is illustrated in communication with six peripheral devices 104, 106, 108, 110, 112 in the WPAN 100, the wireless device 102 may communicate with more or fewer than six peripheral devices within the WPAN 100 without departing from the scope of the present disclosure.

A device, such as the wireless device 102, implementing the BT protocol may operate according to one radio mode, such as basic rate (BR)/enhanced data rate (EDR), and a device implementing the BLE protocol may operation according to a BLE radio mode. In some aspects, a device, such as the wireless device 102, may be configured with dual radio modes, and therefore may be able to operate according to the BR/EDR mode or the BLE mode, for example, based on the type of short-rage wireless communication in which the device may engage.

For example, the device may operate according to the BR/EDR mode for continuous streaming of data, for broadcast networks, for mesh networks, and/or for some other applications in which a relatively higher data rate may be more suitable. However, the device may operate according to the BLE mode for short burst data transmissions and/or for some other applications in which power conservation may be desirable and/or a relatively lower data rate may be acceptable. In other aspects, a device may operate according to one or more other radio modes, including proprietary radio mode, such as high speed radio modes, low energy radio modes, isochronous radio modes, etc.

A short-range wireless communications protocol, such as BT, BLE, and/or BR/EDR, may include and/or may use one or more other communications protocols, for example, for establishing and maintaining communications links. As illustrated, the wireless device 102 may establish a communications link 116 with at least one other device, such as a wireless headset 112, according to at least one communications protocol for short-range wireless communications.

The communications link 116 may include a communications link that adheres to a protocol included and/or for use with BT, BLE, BR/EDR, etc. In one aspect, the communications link 116 may include an asynchronous connection-less (ACL) link. With ACL, the wireless device 102 may connect (or “pair” in the terminology of the BT specification) with a second device, such as the headset 112. The connection is asynchronous in that the two devices may not need to synchronize, time-wise, data communications between each other to permit communication of data packets via the communications link 116.

In one aspect, the communications link 116 may include an Advanced Audio Distribution Profile (A2DP) link. An A2DP link provide for a point-to-point link between a source device, such as the wireless device 102, and a sink device, such as the headset 112. With an A2DP link, data packets including audio may be transmitted over an ACL data channel, and other information, for example, for controlling the audio stream, may be transmitted over a separate control channel. The data packets may occur non-periodically.

In another aspect, the communications link 116 may support synchronous logical transport mechanisms between a “master device” and a “slave device.” For example, the communications link 116 may include a synchronous connection oriented (SCO) link. An SCO link may provide a symmetric point-to-point link between a master device, such as the wireless device 102, and a slave device, such as the headset 112, using time slots reserved for BT communications. However, an SCO link may not support retransmission of data packets, which may be unsatisfactory in audio streaming and/or voice use cases in which a dropped audio or voice packet may reduce the quality of the user experience.

In a further aspect, then, the communications link 116 may include an extended SCO (eSCO) link. An eSCO link may provide a symmetric or asymmetric point-to-point link between a master device and a slave device using time slots reserved for BT communications, and may also provide for a retransmission window following the reserved time slots. Because retransmissions may be facilitated using the retransmission window, an eSCO link may be suitable for audio streaming and/or voice use cases because a dropped audio or voice packet may be retransmitted, and therefore the probability of successfully receiving a data packet may be increased.

In one aspect, the communications link 116 may include an isochronous (ISO) link. With an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped and the receiving device may continue to receive the stream without data from the dropped data packet.

Due to various factors, wireless devices may cause congestion on the frequencies used for wireless channels, such as a wireless channel on which the communications link 116 is carried. Consequently, wireless communication channels, including the wireless communications channel on which the communications link 116 is carried, may be “noisy” in that static, congestion, and/or other interference may introduce random signals on the same frequency bands as those reserved to communicate over established the communications link 116. Such static, congestion, interference, and/or other random signals may cause errors to packets transmitted on the communications link 116 and/or may cause packets to be unreceived over the communications link 116.

In some standards and protocols, such as BLE and/or BR/EDR, the wireless device 102 may detect errors in a packet and/or a dropped/missed/unreceived packet through the use of cyclic redundancy check (CRC) validation and through the use of message integrity code (MIC) validation. MIC validation may be used when a packet is encrypted. For example, failure of CRC validation may indicate one or more errors in a received packet and failure of MIC validation may indicate that another packet has been unreceived (although failure of CRC validation may also indicate another packet has been unreceived and/or failure of MIC validation may also indicate one or more errors in a received packet).

CRC validation and MIC validation may be based on generating CRC values and MICs, respectively, based on received packets and respectively comparing those generated CRC values and MICs to CRC and MICs included in received packets. Specifically, a receiving device that receives a packet, such as the headset 112, may first generate a CRC value or a CRC checksum based on the received packet, such as based on a payload and, if applicable, a MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines the received packet fails CRC validation, then the received packet may include errors and/or may be corrupted. In one configuration, the receiving device may discard the received packet that fails CRC validation; however, in another configuration, the receiving device may attempt to recover the received packet, for example, using one or more error correction techniques.

If the received packet passes CRC validation and is encrypted, then the receiving device may decrypt the received packet to obtain a decrypted payload and a decrypted MIC. For MIC validation, the receiving device may generate a MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation; however, in another configuration, the receiving device may attempt to recover the received packet.

Referring again to FIG. 1, in an illustrative aspect, the wireless device 102 may establish the communications link 116 with the wireless headset 112. In some configurations, however, the wireless headset 112 may include two earpieces 114a, 114b that implement a protocol stack, such as a BT and/or BLE protocol stack, at respective components and/or circuitries. Thus, the communications link 116 may be established at a protocol stack through a first or “primary” earpiece 114a of the headset 112. In effect, when the wireless device 102 establishes the communications link 116 with the headset 112, the communications link 116 is established through the primary earpiece 114a. For example, a logical link, such as an ACL link, A2DP link, etc., may exist at one or more layers of the protocol stack through the primary earpiece 114a.

The wireless device 102 may transmit a set of packets 120 over the communications link 116 to the headset 112. Each of the packets 120 may be a data packet. For example, each of the packets 120 may include a protocol data unit (PDU) having a payload. When one of the packets 120 is decoded and decrypted, the payload may be obtained and output, for example, as audio through a speaker of the headset 112. As packets 120 are streamed over the communications link 116, the headset 112 may stream audio through a speaker of the headset 112.

According to various configurations, each of the packets 120 may be transmitted to the headset 112 by addressing the primary earpiece 114a, for example, using a logical transport address (LT ADDR) or access address of the protocol stack through the primary earpiece 114a. Accordingly, when configured, the primary earpiece 114a may provide (either implicitly or explicitly) acknowledgement (ACK)/negative ACK (NAK) feedback to the wireless device 102 for each of the packets 120.

The communications link 116 toward the primary earpiece 114a may be encrypted in order for MIC validation to be applied by the headset 112. The communications link 116 between the wireless device 102 and the primary earpiece 114a may be encrypted using an encryption mode. In one configuration, the communications link 116 may be encrypted with an Advanced Encryption Standard (AES) with cipher block chaining message authentication code (CBC-MAC) (CCM) (AES-CCM) mode. For example, the wireless device 102 may encrypt each of the packets 120 using a CCM encryption function, and then the wireless device 102 may transmit the encrypted packets 120 over the communications link 116 to the primary earpiece 114a. Correspondingly, the primary earpiece 114a may receive each of the packets 120 over the communications link 116, and the primary earpiece 114a may decrypt each of the packets 120 using a CCM decryption function. In other configurations, the communications link 116 may be encrypted using different encryption modes, and each of the set of packets 120 may be encrypted and decrypted using other encryption functions and/or algorithms.

Encryption and decryption functions may use nonces for the respective encryption and decryption of packets. A nonce may be a key, number, and/or value that is unique to at least a portion of each of the packets—for example, a nonce may be unique for each protocol data unit (PDU) included in each of the packets 120. An encryption function of the wireless device 102 may take a first packet of the packets 120 and a nonce unique to the first packet, and may encrypt at least a portion of the first packet with the nonce.

With reference to the primary earpiece 114a of the headset 112, a decryption function complementary to the encryption function may take the received first packet and a nonce unique to the first packet, and may decrypt the at least the portion of the first packet with the nonce. Thus, the nonce used for encrypting the first packet may be the same as the nonce used for decrypting the first packet.

Because MIC validation may provide authenticity of the packets 120, including confirmation that each of the packets 120 came from the wireless device 102, and integrity of the packets 120, including confirmation that a respective payload of each of the packets 120 has undergone unauthorized modification, the nonces unique to each of the packets 120 should not be sent over the communications link 116. Therefore, the wireless device 102 and the primary earpiece 114a may individually generate the nonces unique to each of the packets 120.

In one configuration, the wireless device 102 and the primary earpiece 114a may individually generate each of the nonces based on a respective packet number of each of the packets 120. Like with the nonces, the wireless device 102 and the primary earpiece 114a may refrain from transmitting the packet numbers over the communications link 116, for example, in order to preserve the authenticity and integrity provided by MIC validation. Therefore, the wireless device 102 and the primary earpiece 114a may be individually responsible for assigning a same packet number to a same packet of the packets 120. For example, the wireless device 102 and the primary earpiece 114a should assign the same packet number to the first packet of the packets 120; otherwise, the nonce used to encrypt the first packet will not match the nonce used to decrypt the first packet and the MIC validation will fail.

In order to maintain consistent packet numbering across each of the packets 120, both the wireless device 102 and the primary earpiece 114a may maintain a respective packet counter for packet numbers corresponding to the packets 120. According to one configuration, the wireless device 102 may increment its packet counter when each packet of the packets 120 is encrypted, for example, the wireless device 102 may increment its packet counter when each of the packets 120 is provided to the encryption function of the wireless device 102. In various configurations, the wireless device 102 may refrain from incrementing its packet counter for unencrypted and/or packets that do not include a payload. Further, the wireless device 102 may refrain from incrementing its packet counter when one of the packets 120 is retransmitted.

Correspondingly, the primary earpiece 114a may increment its packet counter after each packet of the packets 120 is received—for example, the primary earpiece 114a may increment its packet counter when each of the packets 120 is provided to the decryption function of the primary earpiece 114a. In various configurations, the primary earpiece 114a may refrain from incrementing its packet counter for unencrypted and/or packets that do not include a payload. In this way, the wireless device 102 and the primary earpiece 114a may maintain alignment between their respective packet counters.

In one configuration, the wireless device 102 and the primary earpiece 114a may both initialize the respective packet counters to the same value. For example, the wireless device 102 and the primary earpiece 114a may be configured with the same predetermined value with which to initialize the packet counters. In another configuration, the value with which the packet counters are to be initialized may be advertised, such as by the wireless device 102 prior to transmission of the packets 120.

Potentially, the packet counter of the primary earpiece 114a may become unaligned with the packet counter of the wireless device 102. For example, the primary earpiece 114a may drop or miss a first packet of the packets 120 but receive a next packet of the packets 120. However, ACK/NAK feedback (either implicitly or explicitly) provided to the wireless device 102 by the primary earpiece 114a may prevent the packet counter of the primary earpiece 114a from becoming unaligned with the packet counter of the wireless device 102—for example, the wireless device 102 may retransmit the first packet of the packets 120 when the first packet is unreceived by the primary earpiece 114a and NAK feedback for the first packet is indicated at the wireless device 102.

While the packet counters across the wireless device 102 and the primary earpiece 114a remain aligned, nonces generated by the wireless device 102 may correspond to nonces generated by the primary earpiece 114a, and MIC validation may consistently succeed. Accordingly, the primary earpiece 114a may decrypt each of the packets 120, and obtain each payload. The primary earpiece 114a may then provide each payload to another layer (such as a codec), which may process and/or decode the payload and cause the payload to be output, for example, as audio through a speaker of the primary earpiece 114a.

The headset 112, however, may additionally include the secondary earpiece 114b having its own speaker configured output the payloads of the packets 120 as well. Because the communications link 116 may be established toward the primary earpiece 114a, the secondary earpiece 114b may receive the packets 120 by passively monitoring a channel on which the packets 120 are carried on the communications link 116. That is, the secondary earpiece 114b may “sniff” the packets 120 transmitted over the communications link 116 to the primary earpiece 114a.

As the secondary earpiece 114b may sniff the packets 120 from the wireless device 102, the secondary earpiece 114b may need to perform CRC and MIC validation separately from the primary earpiece 114a. Like the primary earpiece 114a, then, the secondary earpiece 114b may successfully decrypt a respective one of the packets 120 using a respective nonce that corresponds to the nonce used by the wireless device 102 to encrypt the respective one of the packets 120. Therefore, the secondary earpiece 114b may maintain a packet counter that is to remain aligned with the packet counter of the wireless device 102.

Similarly, to the primary earpiece 114a, the secondary earpiece 114b may initialize a packet counter to the same value as the wireless device 102. In one configuration, the secondary earpiece 114b may be configured with the same predetermined value as the primary earpiece 114a and the wireless device 102 with which to initialize the packet counter. In other configurations, the value with which the packet counter is to be initialized may be advertised and/or relayed to the secondary earpiece 114b from the primary earpiece 114a.

Potentially, the packet counter of the secondary earpiece 114b may become unaligned with the packet counter of the wireless device 102. For example, the secondary earpiece 114b may drop or miss a first packet of the packets 120 but receive a next packet of the packets 120. However, the secondary earpiece 114b may lack a mechanism to indicate ACK/NAK feedback (either implicitly or explicitly) to the wireless device 102.

While the packet counters across the wireless device 102 and the secondary earpiece 114b remain aligned, nonces generated by the wireless device 102 may correspond to nonces generated by the secondary earpiece 114b, and MIC validation may consistently succeed. Accordingly, the secondary earpiece 114b may decrypt each of the packets 120, and obtain each payload. The secondary earpiece 114b may then provide each payload to another layer (such as a codec), which may process and/or decode the payload and cause the payload to be output, for example, as audio through a speaker of the secondary earpiece 114b.

If the secondary earpiece 114b misses a first packet of the packets 120, the secondary earpiece 114b may decrypt the next packet with the nonce for the first packet. Decrypting the next packet with the nonce for the first packet may cause the next packet to fail MIC validation at the secondary earpiece 114b. This missed packet may have a cascading effect at the secondary earpiece 114b, as each subsequent packet received after the first would be decrypted with the nonce corresponding to the previous packet.

While the secondary earpiece 114b may communicate over a short-range communications link 118 with the primary earpiece 114a so that the primary earpiece 114a may relay packets to the secondary earpiece 114b, the secondary earpiece 114b may also include a mechanism to prevent and/or realign the packet counter of the secondary earpiece 114b.

With such a mechanism for maintaining packet counter alignment, incorrectly decrypted packets may be recovered, overhead incurred due to synchronization and/or relay of missed packets may be reduced, and/or offline MIC recovery may be reduced. Further, scenarios in which a short-range wireless communications link is to be reestablished in order to realign respective packet counters may be avoided.

Accordingly, the secondary earpiece 114b may maintain a packet counter set to an expected packet number associated with a nonce for decryption of an expected packet. The secondary earpiece 114b may consecutively increment the packet counter to the next expected packet number based on each successfully decrypted packet received from the wireless device 102.

The secondary earpiece 114b may receive a first packet of the packets 120 over the communications link 116 from the wireless device 102. The secondary earpiece 114b may decrypt the first packet using a first nonce associated with a first expected packet number. The secondary earpiece 114b may validate a first MIC included in the first packet based on decrypting the first packet. If the MIC is validated, then the first packet may be successfully decrypted, and the first packet may be provided to the upper layer(s) (such as a codec) of the secondary earpiece 114b, for example, to be output as audio through a speaker of the secondary earpiece 114b.

When the first packet is successfully decrypted, then the packet counter of the secondary earpiece 114b may still be aligned with the packet counter of the wireless device 102. Accordingly, the secondary earpiece 114b may consecutively increment the packet counter to the next expected packet number (such as the second expected packet number), which may correspond to the next nonce to be used to decrypted the next expected packet.

However, when the first packet is unsuccessfully decrypted, then the packet counter of the secondary earpiece 114b may be unaligned with the packet counter of the wireless device 102. For example, if MIC validation fails for the first packet, then the secondary earpiece 114b may determine that the packet counter of the secondary earpiece 114b is unaligned with that of the wireless device 102. Accordingly, the secondary earpiece 114b may attempt to realign the packet counter of the secondary earpiece 114b with that of the wireless device.

According to various configurations, the secondary earpiece 114b may determine the next expected packet number when the first packet is unsuccessfully decrypted. However, the next expected packet number may be nonconsecutive to the first packet expected packet number. Because the first packet was unsuccessfully decrypted with the first nonce corresponding to the first expected packet number, the packet counter of the secondary earpiece 114b is unaligned and the next packet will likely be unsuccessfully decrypted if the next nonce corresponding to the next consecutive packet number is used to decrypt the next packet.

In one aspect, the unsuccessfully decrypted first packet may be a retransmission of an earlier, successfully decrypted packet. The secondary earpiece 114b may determine that the first packet is a retransmission of an earlier, successfully decrypted packet by comparing a first set of octets associated with a first CRC and/or MIC of the first packet with a previous set of octets associated with a previous CRC and/or MIC of the earlier packet. If the first set of octets matches the previous set of octets, then the first packet is a retransmission of the earlier packet. When the first packet is a retransmission, then the secondary earpiece 114b may maintain the packet counter with the first expected packet number because the next expected packet will likely correspond to the first expected packet number.

If the first packet is not a retransmission of the earlier packet, then at least one packet was likely missed. When at least one packet is missed, the secondary earpiece 114b may increment the packet counter by more than one. For example, if the secondary earpiece 114b has the packet counter set to x, but fails to successfully decrypt the first packet with the nonce corresponding to x, then the first packet likely corresponds to an expected packet number of x+1, x+2, x+3, or x+4.

In order to determine which expected packet number corresponds to the first packet, the secondary earpiece 114b may compare an expected sequence number to a sequence number included in the first packet. In some configurations, the sequence number may be a binary value that may alternate with each packet sent by the wireless device. For example, if the first packet has a sequence number of 0, then the secondary earpiece 114b may expect the next expected packet to have a sequence number of 1 and, further, a third packet after the next expected packet would be expected to have a sequence number of 0 again. Thus, the secondary earpiece 114b may determine the next expected packet number further based on the sequence number.

In one aspect, the secondary earpiece 114b may be configured with two nonces. That is, the secondary earpiece 114b may be configured to decrypt the first packet using a first nonce corresponding to the first expected packet number x, or decrypt the first packet using a second nonce corresponding to the next consecutive packet number x+1. The secondary earpiece 114b may select between the first and second nonces based on the expected sequence number and the sequence number that is included in the first packet. That is, the secondary earpiece 114b may select the one of the first or second nonce that is associated with an expected sequence number that matches the sequence number included in the first packet. For example, the first nonce may be associated with the expected sequence number s and the second nonce may be associated with the next expected sequence number s′. If the first packet includes a sequence number s′, then the secondary earpiece 114b may select the second nonce because the second nonce is associated with the next expected sequence number s′ that matches the sequence number included in the first packet. If the secondary earpiece 114b successfully decrypts the first packet using the second nonce, then the secondary earpiece 114b may determine that the next expected packet number should be set to x+2, which may be the consecutive packet number following the next consecutive packet number x+1, and the next expected sequence number would then become s, which may be the next sequence number following s′.

However, if the secondary earpiece 114b unsuccessfully decrypts the first packet using the selected first or second nonce and the first packet is not a retransmission of an earlier packet, then the next expected packet likely corresponds to another packet number that is consecutively after the next expected packet number, such as x+2, x+3, or x+4.

As described herein, the secondary earpiece 114b may be configured to determine the next expected packet number when the next expected packet number is determined to be nonconsecutive with the first expected packet number and/or current expected packet number. When the secondary earpiece 114b determines the next expected packet number, the secondary earpiece 114b may align the packet counter with that of the wireless device, and may decrypt the next expected packet when received using a nonce corresponding to the determined next expected packet number.

One or more of the illustrated wireless devices, such as the wireless device 102 or the headset 112, may include suitable logic, circuitry, interfaces, processors, and/or code that may be used for the error correction techniques as described herein when communicating with another device, such as one or more peripheral devices 104, 106, 108, 110, 112. The wireless device 102 may operate to establish a short-range wireless communications connection with at least one of the peripheral devices 104, 106, 108, 110, 112, and the wireless device 102 may establish the communications link 116 with at least one of the peripheral devices 104, 106, 108, 110, 112. With respect to BT, for example, the wireless device 102 may establish the communications link 116 through a link manager (LM) with an intended peripheral device 104, 106, 108, 110, 112. With respect to BLE, for example, the wireless device 102 may establish the communications link 116 through a link layer (LL) with an intended peripheral device 104, 106, 108, 110, 112.

Referring again to FIG. 1, in certain aspects, the wireless device 102 and/or a peripheral device, such as the headset 112, may be configured to establish a communications link 116, and a secondary earpiece 114b of the headset 112 may be configured to align a packet counter of the secondary earpiece 114b with a packet counter of the wireless device 102 when the secondary earpiece 114b is passively monitoring for packets 120 sent to the primary earpiece 114a of the headset 112, as described herein.

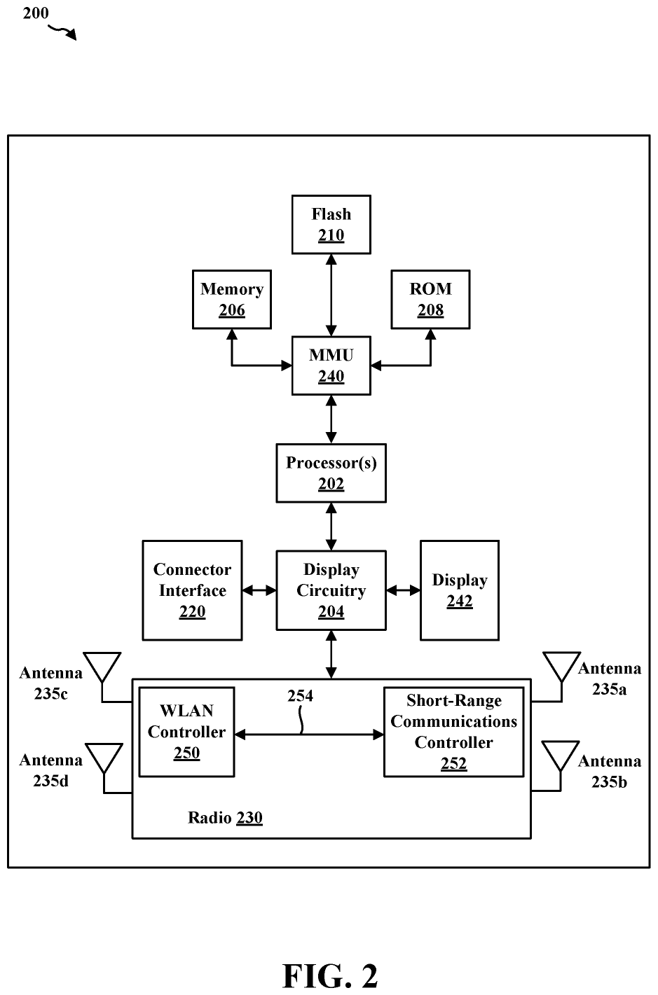

FIG. 2 is block diagram of a wireless device 200 in accordance with certain aspects of the disclosure. The wireless device 200 may correspond to, for example, the wireless device 102, and/or one of the peripheral devices 104, 106, 108, 110, 112 in FIG. 1. In certain configurations, the wireless device 200 may be, for example, a BT and/or BLE device that is configured to align a packet counter with another wireless device when the wireless device unsuccessfully decrypts a packet received from the other wireless device.

As shown in FIG. 2, the wireless device 200 may include a processing element, such as a processor(s) 202, which may execute program instructions for the wireless device 200. The wireless device 200 may also include display circuitry 204, which may perform graphics processing and provide display signals to a display 242. The processor(s) 202 may also be coupled to a memory management unit (MMU) 240, which may be configured to receive addresses from the processor(s) 202 and translate those addresses to locations in memory, such as memory 206, ROM 208, Flash memory 210, and/or to other circuits or devices, such as the display circuitry 204, a radio 230, a connector interface 220, and/or the display 242. The MMU 240 may be configured to perform memory protection and page table translation or set up. In some aspects, the MMU 240 may be included as a portion of the processor(s) 202.

As shown, the processor 202 may be coupled to various other circuits of the wireless device 200. For example, the wireless device 200 may include various types of memory, the connector interface 220, which may allow for coupling to the computer system, the display 242, and/or wireless communications circuitry, which may facilitate Wi-Fi, BT, BLE, etc. The wireless device 200 may include a plurality of antennas 235a, 235b, 235c, 235d, for performing wireless communication with other short-range wireless communications devices, including BT devices, BLE devices, etc.

In certain aspects, the wireless device 200 may include hardware and software components (a processing element) configured to separately check the header of the data packet for errors and perform majority voting of a data packet, for example, using the techniques described herein. The wireless device 200 may also include firmware or other hardware/software for controlling short-range wireless communications operations, such as BT operations, BLE operations, etc. In addition, the wireless device 200 may store and execute a WLAN software driver for controlling WLAN operations.

The wireless device 200 may be configured to implement part or all of the error correction techniques described herein, for example, by executing program instructions stored on a memory medium, such as a non-transitory computer-readable memory medium, and/or through hardware or firmware operation. In other aspects, the error correction techniques described herein may be at least partially implemented by a programmable hardware element, such as an field programmable gate array (FPGA), and/or as an application specific integrated circuit (ASIC).

In certain aspects, the radio 230 may include separate controllers configured to control communications for various respective radio access technology (RAT) protocols. For example, as shown in FIG. 2, radio 230 may include a wireless local area network (WLAN) controller 250 configured to control WLAN communications and a short-range communications controller 252 configured to control short-range communications, such as BT communications, BLE communications, etc. A coexistence interface 254 may be used for sending information between the WLAN controller 250 and the short-range communications controller 252.

In some aspects, one or more of the WLAN controller 250 and/or the short-range communications controller 252 may be implemented as hardware, software, firmware or some combination thereof.

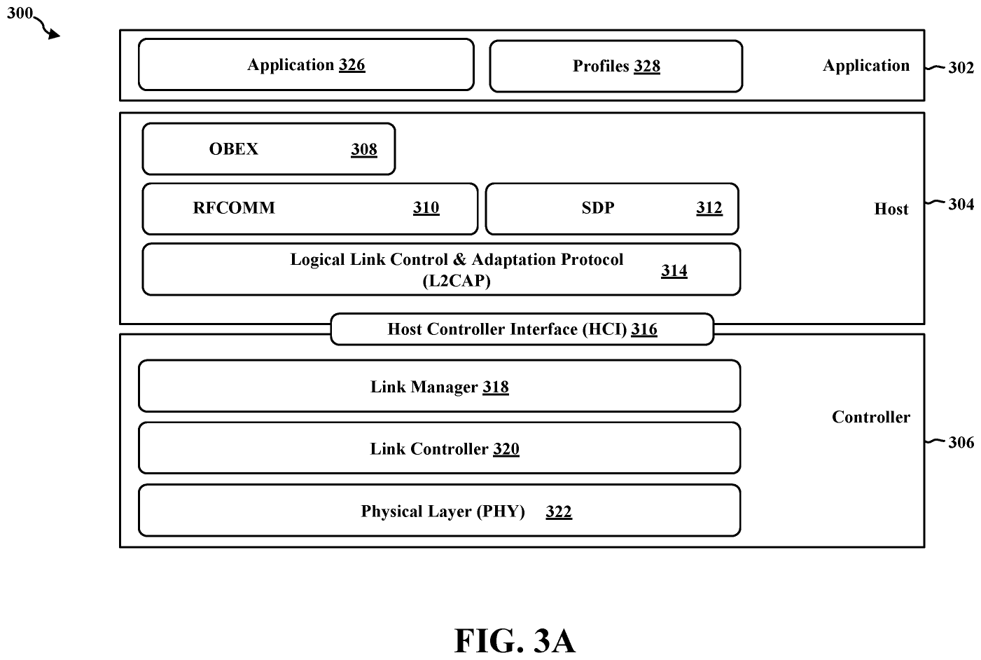

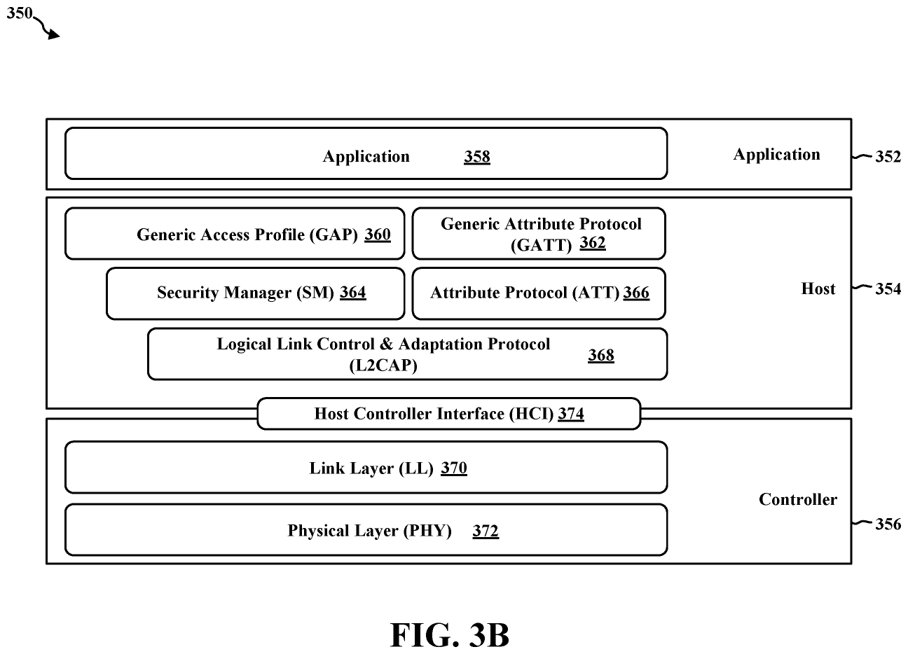

In certain aspects, the WLAN controller 250 may be configured to communicate with a second device using a WLAN link using all of the antennas 235a, 235b, 235c, 235d. In certain configurations, the short-range communications controller 252 may be configured to implement a short-range wireless communications protocol stack, such as a BT stack (FIG. 3A, infra) and/or a BLE stack (FIG. 3B, infra), and communicate with at least one second wireless device using one or more of the antennas 235a, 235b, 235c, 235d. The short-range communications controller 252 may be configured to align a packet counter of the wireless device 200 with a packet counter of another wireless device when the wireless device 200 is passively monitoring for packets sent by the other wireless device.

FIG. 3A illustrates a BT protocol stack 300 that may be implemented in a wireless device in accordance with certain aspects of the disclosure. For example, the BT protocol stack 300 may be implemented by one or more of processor(s) 202, memory 206, Flash memory 210, ROM 208, the radio 230, and/or the short-range communications controller 252 illustrated in FIG. 2.

Referring to FIG. 3A, the BT protocol stack 300 may be organized into lower layer(s), a middle layer(s), and upper layer(s). The lower layer(s) of the BT protocol stack 300 may include a controller stack 306, which may be used for, inter alia, hardware interface management, link establishment, and link management. The middle layer(s) of the BT protocol stack 300 may include a host stack 304, which may be used for, inter alia, application (layer) interface management to allow an application (layer) to access short-range wireless communications. The higher layer(s) of the BT protocol stack 300 may include an application layer 302, which may include one or more applications and one or more profiles that allow the one or more applications to use BT communications.

The controller stack 306 may include a physical (PHY) layer 322. The PHY layer 322 may include, for example, a radio and/or a baseband processor. In some aspects, the PHY layer 322 may define the mechanism for transmitting a bit stream over a physical link or channel that connects BT devices. The bit stream may be grouped into code words or symbols, and converted to a data packet that is transmitted over a wireless transmission medium. The PHY layer 322 may provide an electrical, mechanical, and/or procedural interface to the wireless transmission medium. The PHY layer 322 may be responsible for modulation and demodulation of data into radio frequency (RF) signals for transmission over the air. The PHY layer 322 may describe the physical characteristics of a wireless device's receiver/transmitter. The physical characteristics may include modulation characteristics, radio frequency tolerance, sensitivity level, etc.

The controller stack 306 may further include a link controller 320. The link controller 320 may be responsible for properly formatting data for providing to and obtaining from the PHY layer 322. Further, the link controller 320 may perform synchronization of links, including logical links including ACL links, A2DP links, SCO links, eSCO links, ISO links, etc. The link controller 320 may be responsible for executing commands and instructions issued by a link manager 318, including establishing and maintaining links instructed by the link manager 318.

The link manager 318 may translate host controller interface (HCI) 316 commands into controller-level operation, such as baseband-level operations. The link manager 318 may be responsible for establishing and configuring links and managing power-change requests, among other tasks. Each type of logical link, such as ACL links, A2DP links, SCO links, eSCO links, ISO links, etc., may be associated with a specific packet type. For example, an SCO link may provide reserved channel bandwidth for communication between a master device and a slave device, and support regular, periodic exchange of data packets with no retransmissions. An eSCO link may provide reserved channel bandwidth for communication between a master device and a slave device, and support regular, periodic exchange of data packets with retransmissions. An ACL link may exist between a master device and a slave device from the beginning of establishment of a connection between the master device and the slave device, and the data packets for ACL links may include encoding information in addition to a payload.

The link manager 318 may communicate with the host stack 304 through a host controller interface (HCI) 316—for example, the link manager 318 may translate HCI 316 commands into controller-level operations, such as baseband-level operations. The HCI 316 may act as a boundary between the lower layers, such as the controller stack 306, of the BT protocol stack 300 and the other layers of the BT protocol stack, such as the host stack 304 and/or the application layer 302. The BT specification may define a standard HCI to support BT systems that are implemented across two separate processors. For example, a BT system on a computer might use the BT system's own processor to implement the lower layers of the stack, such as the PHY layer 322, the link controller 320, and/or the link manager 318. The BT system might use a processor of a BT component to implement the other layers, such as the host stack 304 and the application layer 302. In some aspects, however, the BT system may be implemented on a same processor, and such a BT system may be referred to as “hostless.”

The host stack 304 may include at least a Logical Link Control and Adaptation Protocol (L2CAP) layer 314, a service discovery protocol (SDP) layer 312, a radio frequency communication (RFCOMM) layer 310, and an object exchange (OBEX) layer 308. The L2CAP layer 314 is implemented above the HCI 316, and may communicate through the HCI 316. The L2CAP layer 314 may be primarily responsible for establishing connections across some existing links, such as logical links including ACL links, and/or requesting some links if those do not already exist. Further, the L2CAP layer 314 may implement multiplexing between different higher-layer protocols, such as SDP protocols and RFCOMM protocols, which may to allow different applications to use a single link, such as a logical link, including an ACL link. In addition, the L2CAP layer 314 may repackage data packets received from higher layers into a format expected by lower layers. The L2CAP layer 314 may employ the concept of channels to keep track of where data packets come from and where data packets should go. A channel may be a logical representation of the data flow or stream between the L2CAP layer 314 at a transmitting device (such as a master device) and another L2CAP layer 314 at a receiving device (such as a slave device.

The SDP layer 312 may define actions for both servers and clients of BT services. The BT specification defines a service as any feature that may be usable by another (remote) BT device. An SDP client may communicate with an SDP server using a reserved channel on an L2CAP link to discover what services are available. When the SDP client finds the desired service, the SDP client may request a separate connection to use the service. The reserved channel may be dedicated to SDP communication so that a device knows how to connect to the SDP service on any other device. An SDP server may maintain an SDP database, which may include a set of service records that describe the services the SDP server offers. Along with information describing how an SDP client can connect to the service, the service records may contain a universally unique identifier (UUID) of the service.

The RFCOMM layer 310 may emulate the serial cable line settings and status of an RS-232 serial port. The RFCOMM layer 310 may connect to the lower layers of the BT protocol stack 300 through the L2CAP layer 314. By providing serial-port emulation, the RFCOMM layer 310 may support legacy serial-port applications. The RFCOMM layer 310 may also support the OBEX layer 308.

The OBEX layer 308 may define a communication protocol that may be used by devices to exchange data objects, and the data objects may also be defined by the OBEX layer 308. A BT device that wants to set up an OBEX communication session with another device may be considered the client device. The client initially may send one or more SDP requests to ensure that the other device can act as a server of OBEX services. If the server device can provide OBEX services, the server device may respond with the OBEX service record of the server device. The OBEX service record may contain an RFCOMM channel number that the client device may use to establish an RFCOMM channel. Further communication between the two devices may be conveyed in packets, which may contain requests, responses, and/or data. The format of the packet may be defined by the OBEX session protocol.

The application layer 302 may include at least one application 326, with which a user may interact and which may access BT communications for various functionality. The application 326 may access BT communications through one or more profiles 328, which may describe a variety of different types of tasks. By following procedures of one or more profiles 328, the application 326 may use BT communications according to a BT specification.

FIG. 3B illustrates a BLE protocol stack 350 that may be implemented in a BLE device. For example, the BLE protocol stack 350 may be implemented by one or more of processor(s) 202, memory 206, Flash memory 210, ROM 208, the radio 230, and/or the short-range communications controller 252 illustrated in FIG. 2.

The BLE protocol stack 350 may be organized into three layers, which may include, an application layer 352, a host stack 354, and a controller stack 356. The controller stack 356 may be below the host stack 354 and the application layer 352 in the BLE protocol stack 350. The controller stack 356 may include a PHY layer 372 and a LL 370.

The PHY layer 372 may define the mechanism for transmitting a bit stream over a physical link that connects BLE devices. The bit stream may be grouped into code words or symbols, and converted to a data packet that is transmitted over a transmission medium. The PHY layer 372 may provide an electrical, mechanical, and procedural interface to the transmission medium. The shapes and properties of the electrical connectors, the frequency band used for transmission, the modulation scheme, and similar low-level parameters may be specified by the PHY layer 372.

The LL 370 is responsible for low-level communication over the PHY layer 372. The LL 370 manages the sequence and timing for transmitting and receiving data packets, and using a LL protocol, communicates with other devices regarding connection parameters and data flow control. The LL 370 also provides gatekeeping functionality to limit exposure and data exchange with other devices. If filtering is configured, the LL 370 maintains a list of allowed devices and will ignore all requests for data exchange from devices not on the list. The LL 370 may also reduce power consumption. In some aspects, the LL 370 may include a company's proprietary LL that may be used to discover peer devices, and establish a secure communication channel therewith. In certain aspects, the LL 370 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The BLE protocol stack 350 may include an HCI 374, which may act as a boundary between the lower layers (such as the controller stack 356) of the BLE protocol stack 350 and the other layers of the BLE protocol stack (such as the host stack 354 and the application layer 352). In addition, the host stack 354 may communicate with a BLE controller (such as the short-range communications controller 252 in FIG. 2) in a wireless device using the HCI 374. The LL 370 may use the HCI 374 to communicate with the host stack 354 of the BLE protocol stack 350. While some BLE systems may be “hostless,” in that the host stack 354 and the controller stack 356 may be implemented on a same processor, the HCI 374 may also allow the host stack 354 to communicate with different controller stacks 356, such as when the controller stack 356 is implemented on a second processor.

The host stack 354 may include a generic access profile (GAP) 360, a generic attribute protocol (GATT) 362, a security manager (SM) 364, an attribute protocol (ATT) 366, and an L2CAP layer 368. The L2CAP layer 368 may encapsulate multiple protocols from the upper layers into a data packet format (and vice versa). The L2CAP layer 368 may also break packets with a large data payload from the upper layers into multiple packets with the data payload segmented into smaller size data payloads that fit into a maximum payload size (for example, twenty-seven bytes) on the transmit side. Similarly, the L2CAP layer 368 may receive multiple data packets carrying a data payload that has been segmented, and the L2CAP layer 368 may combine the segmented data payload into a single data packet carrying the data payload that will be sent to the upper layers (such as the application layer 352).

The ATT 366 includes a client/server protocol based on attributes associated with a BLE device configured for a particular purpose (examples may include monitoring heart rate, temperature, broadcasting advertisements, etc.). The attributes may be discovered, read, and written by peer devices. The set of operations which are executed over ATT 366 may include, but are not limited to, error handling, server configuration, find information, read operations, write operations, queued writes, etc. The ATT 366 may form the basis of data exchange between BLE devices.

The SM 364 may be responsible for device pairing and key distribution. A security manager protocol implemented by the SM 364 may define how communications with the SM of a counterpart BLE device are performed. The SM 364 provides additional cryptographic functions that may be used by other components of the BLE protocol stack 350. The architecture of the SM 364 used in BLE is designed to minimize recourse requirements for peripheral devices by shifting work to an assumingly more powerful central device. BLE uses a pairing mechanism for key distribution. The SM 364 provides a mechanism to not only encrypt the data but also to provide data authentication.

Above the host stack 354 in the BLE protocol stack 350, the application layer 352 may include an application 358, such as a user application which interfaces with the host stack 354 of the BLE protocol stack 350 for various functionality through BLE communications.

Referring back to the host stack 354, the GATT 362 may provide a service framework using the attribute protocol for discovering services, and for reading and writing characteristic values on a peer device. The GATT 362 may interface with the application 358, for example, through a profile, which may define a collection of attributes and any permission needed for the attributes to be used in BLE communications. The GAP 360 may provide an interface for the application 358 to initiate, establish, and manage connections with other BLE devices.

In some aspects, a wireless device, such as the wireless device 102, the wireless device 200, etc., may be configured to communicate according to different standards and/or protocols. For example, the wireless device may be configured with both BT and BLE for short-range wireless communications. Accordingly, the wireless device may be configured with both the BT protocol stack 300 and the BLE protocol stack 350. In some aspects, one or more layers may be configured for use in both the BT protocol stack 300 and the BLE protocol stack 350—for example, the L2CAP layers 314, 368 of the protocol stacks 300, 350 may be configured for dual mode short-range wireless communications using either BT or BLE.

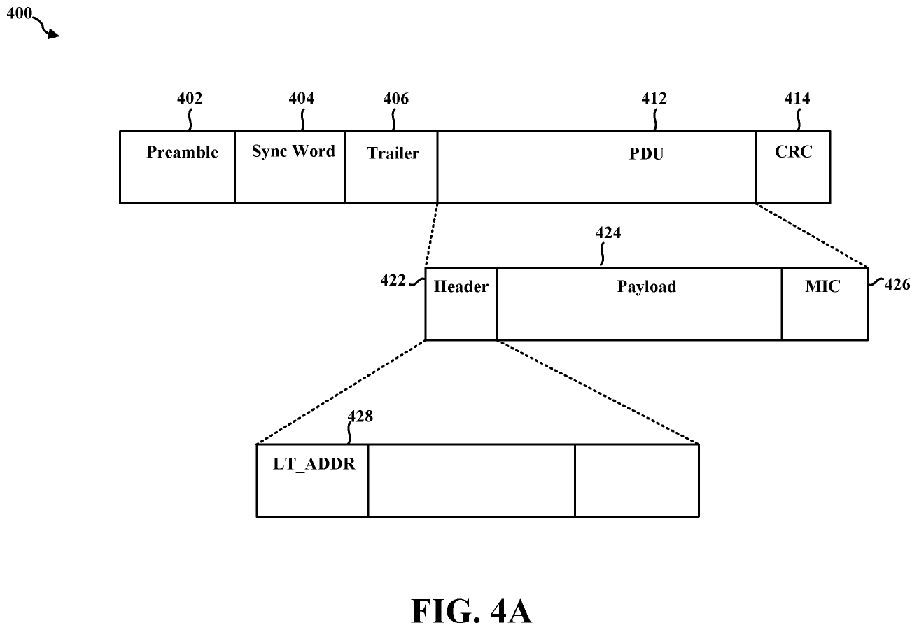

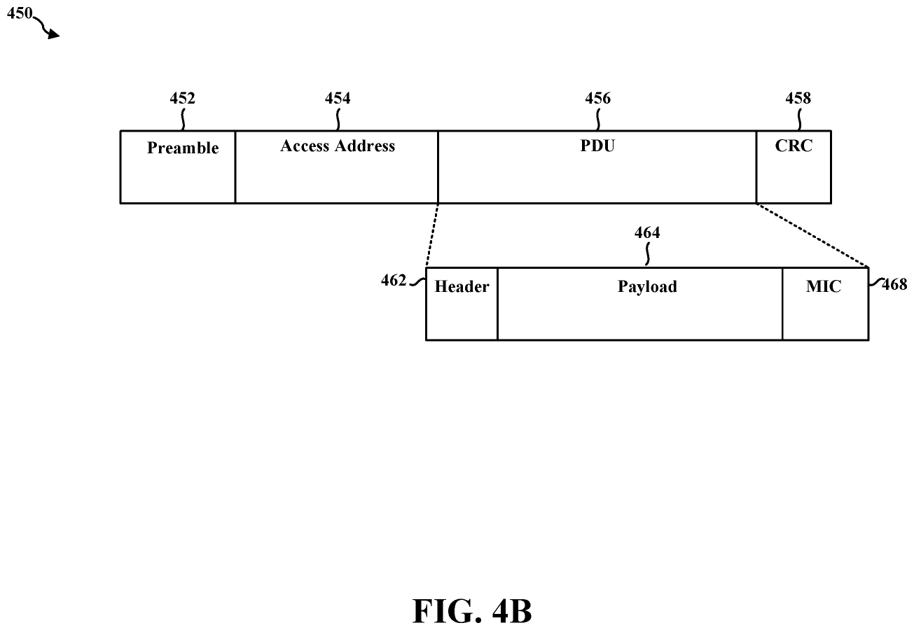

FIG. 4A is a diagram illustrating a data packet 400 in accordance with certain aspects of the present disclosure. The data packet may be used with various short range wireless communications technologies, such as BT and including BR/EDR. The data packet 400 may include a preamble 402, a sync word 404, a trailer 406, a PDU 412, and a CRC 414. In certain configurations, the data packet 400 may not include the CRC 414.

In certain configurations, the PDU 412 may include a header 422, a payload 424, and a MIC 426. The MIC includes information that may be used to authenticate a data packet, for example, when the data packet is encrypted. In other words, the MIC may be used by the receiving device to confirm and/or authenticate that the message came from the stated transmitting device, and to confirm that the payload 424 has not been changed (which may provide data packet integrity). The MIC 426 protects both payload integrity and the authenticity of the data packet 400 by enabling a receiving device who also possess the secret key to detect any changes to the payload 424. In some aspects, the MIC 426 may be present when the packet 400 is encrypted, such as encrypted using AES-CCM encryption, but may be absent when the packet 400 is unencrypted.

In certain configurations, such as BR/EDR, the PDU 412 may be referred to as a “payload.” In such configurations, the header 422 may be referred to as a “payload header” and the payload 424 may be referred to as “data.” In such configurations, the PDU 412 (or “payload”) may include the MIC 426 (if encrypted) and the CRC 414.

In some aspects, the header 422 of the PDU 412 may include a plurality of fields, including at least an LT ADDR 428. The LT ADDR may indicate a logical transport address. The LT ADDR 428 may be associated with a logical link. For example, a logical transport address included in the LT ADDR 428 may indicate a type of logical link, including ACL, A2DP, eSCO, ISO, etc.

FIG. 4B is a diagram illustrating a data packet 450 in accordance with certain aspects of the present disclosure. The data packet may be used with various short range wireless communications technologies, such as BLE. The data packet 450 may include a preamble 452, an access address 454, a PDU 456, and a CRC 458. In certain configurations, the data packet 450 may not include the CRC 458.

In some aspects, the access address 454 may set the address of a link layer (such as the link layer 370) connection. For example, the access address 454 may include an address that indicates a type of logical link, including ACL, A2DP, eSCO, ISO, etc.

In certain configurations, the PDU 456 may include a header 462, a payload 464, and a MIC 468. The MIC includes information that may be used by to authenticate a data packet, for example, when the data packet is encrypted. In some aspects, the header 462 of the PDU 456 may include a plurality of fields, including at least an logical link identifier (LLID).

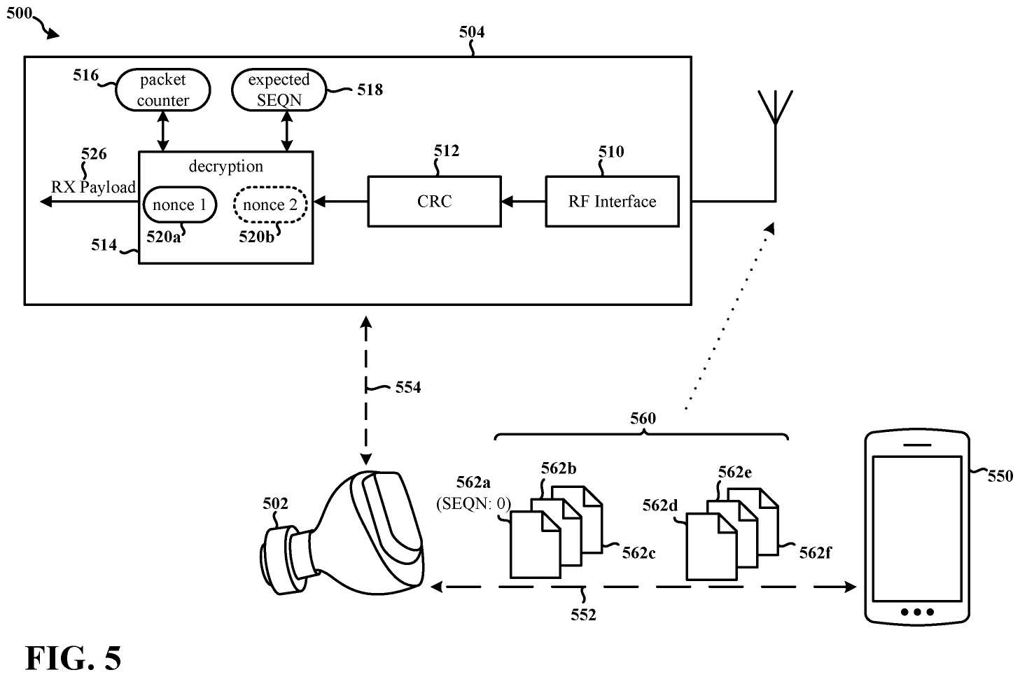

FIG. 5 illustrates a wireless communications system 500, in accordance with various aspects of the present disclosure. The wireless communications system 500 may include at least two devices 504, 550. In certain aspects, one device 550 may be a source device. For example, referring to FIG. 1, the source device 550 may implemented as the wireless device 102, which may send the set of packets 120 over the communications link 116. Continuing with the context of FIG. 1, a set of packets 560 may be transmitted over a communications link 552, which may be implemented as the set of packets 120 and the communications link 116, respectively. Illustratively, the communications link 552 may include a BT, BR/EDR, or BLE link. In various aspects, the communications link 552 may include an ACL link, an A2DP link, an eSCO link, and/or an ISO link, for example, for BT and/or BLE communication.

The source device 550 may establish a communications link 552 with a receiving device, which may be referred to as a “sink” device in some aspects. According to certain configurations, the receiving device may include a primary device 502 and a secondary device 504. For example, the primary device 502 and the secondary device 504 may be two earpieces of a wireless headset. The source device 550 may establish the communications link 552 with the receiving device. For example, referring to FIG. 1, a receiving device may be implemented as the headset 112, and thus the primary device 502 may be implemented as the primary earpiece 114a and the secondary device 504 may be implemented as the secondary earpiece 114b.

According to certain configurations, the source device 550 and the primary device 502 may establish the communications link 552. The source device 550 may transmit a set of packets 560 over the communications link 552 to the primary device 502. For example, the source device 550 may address each of the set of packets 560 to the primary device 502. However, the secondary device 504 may be configured to (passively) monitor a wireless medium that the communications link 552 is on. For example, the secondary device 504 may “sniff” packets on the communications link 552. The secondary device 504, therefore, may receive packets transmitted by the source device 550 over the communications link 552, for example, based on the monitoring.

The primary device 502 may communicate with the secondary device 504 over another communications link 554. The other communications link 554 may be, for example, a BT link, a BLE link, a near-field magnetic induction (NFMI) link, or any other suitable short-range wireless communications link. According to one configuration, the secondary device 504 may receive information associated with the source device 550 and/or the communications link 552 from the primary device 502. In one aspect, the primary device 502 may configure and/or relay one or more parameters to the secondary device 504, and the one or more parameters may facilitate the reception of the set of packets 560 by the secondary device 504 through the monitoring of the communications link 552.

For example, the secondary device 504 may receive information from the primary device 502 indicating the set of packets 560 are to begin streaming over the communications link 552. In further examples, the secondary device 504 may receive information from the primary device 502 indicating an initial expected sequence number of an initial data packet of the set of data packets 560, a value to which the secondary device 504 is to initialize a packet counter 516, a type of the communications link 552, a type of encryption on the communications link 552, and/or any other information that may allow the secondary device 504 to receive the set of packets 560 over the communications link 552 when the secondary device 504 is monitoring for packets over the communications link 552.

FIGS. 1 and 5 of the present disclosure describe the secondary device 504 as a component of a receiving device that includes the primary earpiece 114a and primary device 502, respectively, as examples of possible configurations. According to certain other configurations, the secondary device 504 may be separate from the primary device 502 and may not be communicatively coupled thereto, or the primary device 502 may be absent. Other aspects may be comprehended without departing from the scope of the present disclosure. According to certain other configurations, the secondary device 504 may be any device configured to monitor a wireless medium, receive packets on the wireless medium, and determine a nonce for decrypting the received packets. For example, the secondary device 504 may be implemented in a wireless communications system in which the source device 550 streams a set of packets, and the secondary device 504 does not provide ACK/NACK feedback for each of the set of packets.

The source device 550 may be configured to transmit packets with one or more mechanisms for security and/or integrity. For example, the source device 550 may encrypt packets according to any one of a number of different encryption algorithms or protocols, such as AES-CCM. When encrypting a packet, the source device 550 may generate a MIC based on data that is to be included in the packet, and the source device 550 may append the MIC to the data that is included in a payload of the packet.

The source device 550 may encrypt each of the set of packets 560 using a respective nonce that is associated with a respective packet number corresponding to a respective packet. For example, the source device 550 may generate a nonce based on the packet number x corresponding to the second packet 562b. However, the source device 550 may refrain from transmitting the packet number x—for example, the second packet 562b may not include information indicating that the second packet 562b is associated with packet number x.

In addition, each of the set of packets 560 may also be associated with a sequence number. Sequence numbers for the set of packets 560 may be binary, such as “0” or “1”. The sequence number may alternate for each packet. For example, if a first packet 562a corresponds to a sequence number “0”, then the next consecutive packet 562b may correspond to a sequence number “1”. Unlike packet numbers, the source device 550 may include sequence numbers of each of the set of packets 560 in each of the set of packets 560. The primary device 502 may also store an expected sequence number, and may further use a sequence number of one of the set of packets 560 to provide ACK/NACK feedback to the source device 550. For example, when the expected sequence number does not match the sequence number included in one of the set of packets 560, then the primary device 502 may provide a NACK to the source device 550 for that one of the set of packets 560.

The source device 550 may generate a nonce to encrypt each of the set of packets 560 further based on a respective sequence number associated with a respective packet of the set of packets 560. For example, the source device 550 may generate a nonce based on the packet counter number x corresponding to the second packet 562b and further based on sequence number s (such as “1”). Thus, the source device 550 may use an encryption function to encrypt each of the set of packets 560 that takes as inputs both a respective packet counter number and a respective sequence number corresponding to a respective packet of the set of packets 560. In one aspect, the source device 550 may calculate a MIC over the payload of the second packet 562b of the set of packets 560 using a MIC calculation function that takes as inputs both the packet counter number x corresponding to the second packet 562b and the sequence number s corresponding to the second packet 562b. The source device 550 may then encrypt the payload of the second packet 562b, which may include encrypting the payload header of the second packet 562b, the data of the second packet 562b, and the MIC of the second packet 562b (although the CRC may be excluded from encryption).

In addition to encryption, the source device 550 may be configured to include error-detecting code in packets transmitted over the communications link 552. For example, the source device 550 may be configured to generate a CRC value based on data included in a packet (potentially after encryption), which may include the appended MIC.

In one configuration, referring to FIG. 4A, the source device 550 may transmit a BT and/or BR/EDR packet 400, which may include a MIC 426 appended to a payload 424 and a CRC 414 appended to a PDU 412 that includes both the payload 424 and the MIC 426. In another configuration, referring to FIG. 4B, the source device 550 may transmit a BLE packet 450, which may include a MIC 468 appended to a payload 464 and a CRC 458 appended to a PDU 456 that includes both the payload 464 and the MIC 468.

With reference again to FIG. 5, the secondary device 504 may include, inter alia, an RF interface 510, a CRC component 512, and a decryption component 514. The secondary device 504 may include more or fewer components, according to different configurations. Each of the RF interface 510, CRC component 512, and decryption component 514 may be implemented in hardware, software, firmware, or any combination thereof. For example, referring to FIG. 2, the RF interface 510, the CRC component 512, and/or the decryption component 514 may be included in the short-range communications controller 252.

The RF interface 510 may be coupled with at least one antenna to detect signals when the secondary device is (passively) monitoring the communications link 552. The RF interface 510 may include one or more receive chains, and may be configured to provide (digital) signals to other illustrated components of the secondary device 504.

The CRC component 512 may be configured to generate a CRC value based on a received packet. For example, the CRC component 512 may apply an algorithm to a PDU of a received packet before the received packet is decrypted in order to generate a CRC value. The CRC component 512 may compare the generated CRC value with a CRC value included in the received packet. If the CRC component 512 determines that the generated CRC value matches and/or equals the CRC value included in the received packet, then the CRC component 512 may determine the received packet passes CRC validation and may provide the packet to the decryption component 514. If the CRC component 512 determines that the generated CRC value does not match and/or does not equal the CRC value included in the received packet, then the CRC component 512 may determine that the received packet fails CRC validation and may discard the packet.

According to various configurations, the CRC component 512 may store a set of octets corresponding to the CRC value included in a received packet. The CRC component 512 may store the set of octets corresponding to the CRC value of a received packet for each received packet, regardless of whether the packet passes CRC validation. A stored set of octets corresponding to a previous CRC value of a previously received packet may be compared with a current set of octets corresponding to a current CRC value of a current packet. When the stored set of octets matches and/or equals a current set of octets, then the current packet may be a retransmission of the previously received packet.

The decryption component 514 may be configured to decrypt packets that pass CRC validation. For example, the decryption component 514 may apply an algorithm to a PDU of a received packet (including payload header, data, and MIC) in order to decrypt the PDU of the received packet. When the received packet is decrypted, the decryption component 514 may generate an expected MIC, for example, based on at least a portion of the PDU of the received packet, such as the data portion of the PDU. The decryption component 514 may compare the expected MIC with a MIC included in the received packet—for example, the MIC may be included in or appended to the PDU.

If the decryption component 514 determines that the expected MIC matches and/or equals the MIC included in the received packet, then the decryption component 514 may determine the received packet passes MIC validation and may provide the decrypted payload 526 to another layer or component of the secondary device 504, such as a codec that may decode audio data of the payload 526 to be output through a speaker of the secondary device 504. If the decryption component 514 determines that the generated MIC does not match and/or does not equal the MIC included in the received packet, then the decryption component 514 may determine that the received packet fails MIC validation.

The decryption component 514 may decrypt a packet using at least a first nonce 520a. The first nonce 520a may correspond to an expected packet number of a packet counter 516 maintained by the secondary device 504. For example, the decryption component 514 may generate the first nonce 520a based on the expected packet number of the packet counter 516. Further, the decryption component 514 may generate the first nonce 520a based on the expected sequence number 518. When the secondary device 504 receives a packet, the received packet may be expected to correspond to the expected packet number to which the packet counter 516 is currently set and the expected sequence number 518 when the packet is received.

When the decryption component 514 successfully decrypts a received packet, the decryption component 514 may increment the packet counter 516. In one aspect, the decryption component 514 may consecutively increment the packet counter 516 when a received packet is successfully decrypted with the first nonce 520a. In other words, the decryption component 514 may add “1” to the expected packet number to which the packet counter 516 is currently set when the packet is received. Further, the decryption component 514 may change the expected sequence number 518 to the other of the two values (such as “0” or “1”) when a received packet is successfully decrypted with the first nonce 520a.

In another aspect, the decryption component 514 may be configured with a second nonce 520b, in addition to the first nonce 520a. The second nonce 520b may correspond to a next expected packet number of the packet counter 516 and a next expected sequence number following the expected sequence number 518. For example, if the first nonce 520a corresponds to an expected packet number x (for example, the packet counter 516 may be set at x) and expected sequence number s (for example, the expected sequence number may be set at s), then the second nonce 520b may be generated using a next expected packet number x+1 and a next expected sequence number s′, although the packet counter 516 may remain set at x and the expected sequence number may remain set at s.

The decryption component 514 may use the second nonce 520b as an alternative to the first nonce 520a to decrypt a received packet. The decryption component 514 may determine to use the first nonce 520a or the second nonce 520b based on the sequence numbers respectively associated with the first nonce 520a and the second nonce 520b. In one configuration, the decryption component 514 may determine the first nonce 520a or the second nonce 520b by comparing the sequence number associated with the first nonce 520a and the sequence number associated with the second nonce 520b to the sequence number included in a received packet. The decryption component 514 may then select the one of first or second nonces 520a, 520b associated with a respective sequence number that matches the sequence number included in the received packet.

If the decryption component 514 is configured with two nonces 520a, 520b, the decryption component 514 may increment the packet counter 516 based on which of the nonces 520a, 520b is used to successfully decrypt a packet. Thus, the decryption component 514 may consecutively increment the packet counter 516 when a received packet is successfully decrypted with the first nonce 520a. However, if the decryption component 514 successfully decrypts the packet with the second nonce 520b, then the decryption component 514 may add “2” to the expected packet number to the packet counter 516 is set when the packet is received. For example, if the first nonce 520a corresponds to an expected packet number x (when the packet counter 516 is currently set to x) and the second nonce 520b corresponds to a next expected packet number x+1, then the decryption component 514 may set the packet counter 516 to x+2 if the decryption component 514 successfully decrypts a packet with the second nonce 520b.

In addition, the decryption component 514 may change the expected sequence number 518 based on which of the nonces 520a, 520b is used to successfully decrypt a packet. For example, the decryption component 514 may change the expected sequence number to s′ when a received packet is successfully decrypted with the first nonce 520a associated with a sequence number s. However, if the decryption component 514 successfully decrypts the packet with the second nonce 520b, then the decryption component 514 may change the expected sequence number to s when a received packet is successfully decrypted with the second nonce 520b associated with a sequence number s′.

In this way, the secondary device 504 may have a mechanism to keep the packet counter 516 aligned with that of the source device 550 if one packet is dropped or missed. However, the decryption component 514 may be unsuccessfully in decrypting a received packet even with two nonces 520a, 520b. The secondary device 504 may still be configured to align the packet counter 516 with a packet counter of the source device 550 using the techniques and approaches described herein. For example, the decryption component 514 may determine a next nonce based on decrypting a received packet using the first nonce 520a or, if configured, the second nonce 520b, and the next nonce when the received packet is successfully decrypted may be different from that when the received packet is unsuccessfully decrypted. Specifically, the decryption component 514 may determine that the next nonce is associated with a next consecutive packet number and a next expected sequence number when the received packet is successfully decrypted. However, the decryption component 514 may determine that the next nonce is associated with at least one of a packet number that is non-consecutive to the received packet number and/or a sequence number that is the same as the sequence number of the received packet when the received packet is unsuccessfully decrypted.

The source device 550, the primary device 502, and the secondary device 504 may individually maintain their own respective packet counters to correspond to the set of packets 560 as each of the set of packets 560 is transmitted and received (and decrypted). As described, supra, the packet numbers to which the packet counters are set may not be transmitted over the communications link 552 because the packet numbers of the packet counters may be used to encrypt and decrypt the set of packets 560.

In order to first determine the nonce to use for decrypting each of the set of packets 560 transmitted over the communications link 552, the secondary device 504 may initialize the packet counter 516. In one configuration, the secondary device 504 may initialize the packet counter 516 to a default or preconfigured initial packet number, such as “0.” In another configuration, the secondary device 504 may initialize the packet counter 516 based on information received from the primary device 502 over the other communications link 554 and/or based on information communicated between the source device 550 and the primary device 502 that the secondary device 504 detects on the communications link 552.

Similarly, the secondary device 504 may initialize the expected sequence number 518.

In one configuration, the secondary device 504 may initialize the expected sequence number 518 to a default or preconfigured initial sequence number, such as “0.” In another configuration, the secondary device 504 may initialize the expected sequence number 518 based on information received from the primary device 502 over the other communications link 554 and/or based on information communicated between the source device 550 and the primary device 502 that the secondary device 504 detects on the communications link 552.

Having the packet counter 516 initialized, the secondary device 504 may determine at least the first nonce 520a. For example, the secondary device 504 may generate the first nonce 520a based on a decryption function that takes a set of inputs (such as an AES-CCM decryption function), and at least one of the inputs may be the expected packet number to which the packet counter 516 is set. Further, the decryption function may take the expected sequence number 518 as another of the set of inputs. The secondary device 504 may load the first nonce 520a into the decryption component 514—for example, the secondary device 504 may load the first nonce 520a into hardware and/or software of the decryption component 514.

If configured with two nonces, the secondary device 504 may further determine the second nonce 520b. For example, the secondary device 504 may generate the second nonce 520b based on the aforementioned decryption function, although the at least one of the inputs may be a next expected packet number of the packet counter 516, and another one of the inputs may be a next expected sequence number following the expected sequence number 518. The next expected packet number may be the next consecutive value following the expected packet number to which the packet counter 516 is set. For example, if the packet counter 516 is set to an expected packet number x, the packet counter 516 may remain set at x but the second nonce 520b may be generated based on the next consecutive expected packet number x+1. The next expected sequence number may be the other of the two binary values to which the expected sequence number 518 is set. For example, if the expected sequence number 518 is set to an expected sequence number s, the expected sequence number 518 may remain set at s but the second nonce 520b may be generated based on the next expected sequence number s′. As with the first nonce 520a, the secondary device 504 may load the second nonce 520b into the decryption component 514—for example, the secondary device 504 may load the second nonce 520b into hardware, software, and/or firmware of the decryption component 514.

After the communications link 552 is established, the source device 550 may begin transmitting the set of packets 560 over the communications link 552. The source device 550 may sequentially transmit each of the set of packets 560, for example, to the primary device 502. The secondary device 504 may be (passively) monitoring the communications link 552. Thus, when the source device 550 transmits a first packet 562a to the primary device 502, the RF interface 510 of the secondary device 504 may detect and receive the first packet 562a.

By way of illustration, the first packet 562a may have a sequence number “0”, which may be included in the first packet 562a by the source device 550. The secondary device 504 may maintain an expected packet number 518. Thus, assuming the packet counter 516 is aligned with the packet counter of the source device 550, the expected sequence number 518 may be set to “0” to correspond to the first packet 562a when the first packet 562a is received.

Further, the first packet 562a may correspond to a packet number x−1. The secondary device 504 may maintain the packet counter 516 set to an expected packet number. Accordingly, assuming the packet counter 516 is aligned with the packet counter of the source device 550, then the packet counter 516 may be set to an expected packet number of x−1 when the first packet 562a is received.

The CRC component 512 of the secondary device 504 may first perform CRC validation of the first packet 562a. Regardless of whether the first packet 562a passes CRC validation, the CRC component 512 may store a set of octets corresponding to the CRC value included in the first packet 562a. According to an example, the CRC component 512 may determine the first packet 562a passes CRC validation. When the first packet 562a passes CRC validation, the CRC component 512 may provide the first packet 562a to the decryption component 514.

The decryption component 514 of the secondary device 504 may decrypt the first packet 562a using at least the first nonce 520a, which may be loaded for the decryption component 514 before the first packet 562a arrives at the decryption component 514. For example, the decryption component 514 may generate the first nonce 520a based on the expected sequence number “0” to which the expected sequence number 518 is set and further based on the expected packet number x−1 to which the packet counter 516 is set. The decryption component 514 may determine whether the first packet 562a is successfully decrypted, for example, by comparing a MIC generated based on the decrypted first packet 562a to the MIC included in the decrypted first packet 562a.

According to an example, the decryption component 514 may determine that the first packet 562a is successfully decrypted. If the secondary device 504 is configured with the second nonce 520b, then the decryption component 514 may refrain from using the second nonce 520b when the first packet 562a is successfully decrypted with the first nonce 520a.

Further, when the first packet 562a is successfully decrypted, the secondary device 504 may set the expected sequence number 518 to “1”, which is the other value of the two possible values for the sequence number. Additionally, the secondary device 504 may consecutively increment the packet counter 516 to an expected packet number that is consecutive to the packet number corresponding to the one of the nonces 520a, 520b used to successfully decrypt the first packet 562a. According to one example, the decryption component 514 may use the first nonce 520a to successfully decrypt the first packet 562a. Therefore, the secondary device 504 may consecutively increment the packet counter 516 to x, which may be the next expected packet number that is consecutive to the packet number x−1 corresponding to the first nonce 520a used to successfully decrypt the first packet 562a.

The decryption component 514 may then provide the successfully decrypted payload 526 of the first packet 562a to another layer (such as a codec) of the secondary device. For example, the decryption component 514 may provide the payload 526 to a codec, which may output the payload 526 as audio through a speaker of the secondary device 504.

According to some aspects, the decryption component 514 may store a set of octets corresponding to the MIC included in the first packet 562a. In one configuration, the decryption component 514 may store the set of octets corresponding to the encrypted MIC included in the first packet 562a. For example, the decryption component 514 may store the set of octets corresponding to the MIC included in the first packet 562a before decryption of the first packet 562a.

Following the first packet 562a, the source device 550 may transmit a second packet 562b to the primary device 502 over the communications link 552. According to a first example, the second packet 562b may be a retransmission of the first packet 562a, such as in response to NACK feedback from the primary device 502 for the first packet 562a and/or in response to ACK feedback from the primary device 502 that is missed/not received by the source device 550. According to this first example, the source device 550 may encrypt the second packet 562b with a nonce associated with the same packet number as the first packet 562a (for example, packet number x−1) and the same sequence number as the first packet 562a (for example, sequence number “0”). The secondary device 504 may receive the second packet 562b, and the CRC component 512 may determine whether the second packet 562b passes CRC validation. When the CRC component 512 determines that the second packet 562b passes CRC validation, the CRC component 512 may provide the second packet 562b to the decryption component 514.

If the decryption component 514 is configured with one nonce, the decryption component 514 may decrypt the second packet 562b using the first nonce 520a, which is associated with expected sequence number 518 set to “1” and packet counter 516 set to x. If the decryption component 514 is configured with two nonces, the decryption component 514 may decrypt the second packet 562b using the second nonce 520b because the second nonce 520b is associated with the next expected sequence number “0” that matches the sequence when included in the second packet 562b. In either case, the decryption component 514 may determine that the second packet 562b is unsuccessfully decrypted. For example, the decryption component 514 may generate a MIC based on the second packet 562b, and the generated MIC may be different from a MIC included in the second packet 562b. Because the generated MIC does not match the MIC included in the second packet 562b, the decryption component 514 may determine that the second packet 562b is unsuccessfully decrypted.

The decryption component 514 may then compare the CRC octets from the second packet 562b to the CRC octets stored when the first packet 562a was received. Because the second packet 562b is a retransmission of the first packet 562a in this first example, the CRC octets from the second packet 562b may match the CRC octets stored for the previously received first packet 562a. Accordingly, the decryption component 514 may determine that the second packet 562b is a retransmission of the first packet 562a. In which case, the packet counter 516 and expected sequence number 518 may remain unchanged because the next packet following the second packet 562b is expected to now correspond to the current packet counter 516 (for example, packet number x) and expected sequence number 518 (for example, sequence number “1”).

Additionally or alternatively, the decryption component 514 may compare octets corresponding to the MIC from the second packet 562b to octets corresponding to the MIC from the first packet 562a, which may have been stored when the first packet 562a was received. After the decryption component 514 decrypts the respective MICs from the first packet 562a and the second packet 562b, the octets respectively corresponding to the MICs may be different than those octets corresponding to the MICs before decryption. In one configuration, the decryption component 514 may compare octets corresponding to the MIC from the second packet 562b before decryption to octets corresponding to the MIC from the first packet 562a before decryption. That is, the decryption component 514 may compare octets corresponding to the encrypted MIC from the second packet 562b to octets corresponding to the encrypted MIC from the first packet 562a.

Because the second packet 562b may be a retransmission of the first packet 562a in this first example, the MIC octets from the second packet 562b may match the MIC octets stored for the previously received first packet 562a. Accordingly, the decryption component 514 may determine that the second packet 562b is a retransmission of the first packet 562a. In which case, the packet counter 516 and expected sequence number 518 may remain unchanged because the next packet following the second packet 562b is expected to now correspond to the current packet counter 516 (such as packet number x) and expected sequence number 518 (such as sequence number “1”).

According to some other examples, the second packet 562b may be a new packet (that is, the second packet 562b may not be a retransmission of the first packet 562a). Therefore, the source device 550 may encrypt the second packet 562b with a nonce associated with the packet number x and sequence number “1” corresponding to the second packet 562b.

According to a second example, the secondary device 504 may fail to receive the second packet 562b corresponding to expected packet number x to which the packet counter 516 is set, and further corresponding to the expected sequence number 518 set to “1”. The source device 550 may be unaware that the secondary device 504 missed the second packet 562b. Therefore, the source device 550 may encrypt a third packet 562c with a nonce associated with the packet number x+1 and sequence number “0” corresponding to the third packet 562c.

According to the second example, the secondary device 504 may receive the third packet 562c based on passively monitoring the communications link 552. The CRC component 512 may determine that the third packet 562c passes CRC validation, and provide the third packet 562c to the decryption component 514. When the third packet 562c is received, the first nonce 520a is associated with a packet counter 516 set to x and expected sequence number 518 set to “1”, which do not match the respective packet number (such as packet number x+1) and sequence number (such as sequence number “0”) associated with the nonce used by the source device to encrypt the third packet 562c.

If the decryption component 514 is configured with one nonce, then the decryption component 514 may unsuccessfully decrypt the third packet 562c using the first nonce 520a. Further, the decryption component 514 may determine that the CRC and/or MIC octets of the third packet 562c do not match the CRC and/or MIC octets of the most recently received first packet 562a and, therefore, the third packet 562c is not a retransmission of the most recently received first packet 562a. According to one configuration, the decryption component 514 may determine that the received third packet 562c corresponds to packet number x+1. In response, the decryption component 514 may realign the packet counter 516 with that of the source device 550 by setting the packet counter 516 to x+2, which may be the next expected packet number. Further, the decryption component 514 may set the expected sequence number 518 to “1”—for example, the decryption component 514 may not change the expected sequence number 518.

If the decryption component 514 is configured with the two nonces 520a, 520b, then the decryption component 514 may determine that the sequence number “0” included in the third packet 562c does not match the expected sequence number 518 of “1” and the decryption component 514 may select the second nonce 520b corresponding to the next expected sequence number (for example, instead of the first nonce 520a corresponding to the expected sequence number 518 set to “1”). The decryption component 514 may successfully decrypt the third packet 562c using the second nonce 520b. Accordingly, the decryption component 514 may consecutively increment the packet counter 516 to packet number x+2 and may set the expected sequence number to “1”.

In a third example, the secondary device 504 may fail to receive the second packet 562b corresponding to expected packet number x to which the packet counter 516 is set, and corresponding to the expected sequence number 518 set to “1”. Further, the secondary device 504 may fail to receive the third packet 562c, encrypted by the source device 550 using a nonce associated with packet number x+1 and sequence number “0”. However, the secondary device 504 may receive the fourth packet 562d, encrypted by the source device 550 using a nonce associated with packet number x+2 and sequence number “1”.

The CRC component 512 may determine that the fourth packet 562d passes CRC validation, and provide the fourth packet 562d to the decryption component 514. When the fourth packet 562d is received but the second and third packets 562b, 562c are missed, the first nonce 520a is associated with a packet counter 516 set to x and expected sequence number 518 set to “1”, which does not match the respective packet number (such as packet number x+2) associated with the nonce used by the source device 550 to encrypt the fourth packet 562d (although the sequence number “1” does match).

If the decryption component 514 is configured with one nonce, then the decryption component 514 may unsuccessfully decrypt the fourth packet 562d using the first nonce 520a. If the decryption component 514 is configured with two nonces, then the decryption component 514 may unsuccessfully decrypt the fourth packet 562d using the first nonce 520a (selected because the sequence number “0” included in the fourth packet 562d matches that of the expected sequence number 518 associated with the first nonce 520a). When the fourth packet 562d is unsuccessfully decrypted, the decryption component 514 may determine that the CRC and/or MIC octets of the fourth packet 562d do not match the CRC and/or MIC octets of the most recently received first packet 562a and, therefore, the fourth packet 562d is not a retransmission of the most recently received first packet 562a.

In this third example, regardless of whether the decryption component 514 is configured with one or two nonces, the decryption component 514 may determine that the fourth packet 562d corresponds to packet number x+2 based on the unsuccessful decryption but the expected sequence number 518 set to “1” matching the sequence number “1” of the fourth packet 562d. In response, the decryption component 514 may realign the packet counter 516 with that of the source device 550 by setting the packet counter 516 to x+3, which may be the next expected packet number. Further, the decryption component 514 may set the expected sequence number 518 to “0”.

In a fourth example, the secondary device 504 may fail to receive the second packet 562b corresponding to expected packet number x to which the packet counter 516 is set, and corresponding to the expected sequence number 518 set to “1”. Further, the secondary device 504 may fail to receive the third packet 562c, encrypted by the source device 550 using a nonce associated with packet number x+1 and sequence number “0”. Further, the secondary device 504 may fail to receive the fourth packet 562d, encrypted by the source device 550 using a nonce associated with packet number x+2 and sequence number “1”. However, the secondary device 504 may receive the fifth packet 562e, encrypted by the source device 550 using a nonce associated with packet number x+3 and sequence number “0”.

The CRC component 512 may determine that the fifth packet 562e passes CRC validation, and provide the fifth packet 562e to the decryption component 514. When the fifth packet 562e is received but the second, third, and fourth packets 562b, 562c, 562d are missed, the first nonce 520a is associated with a packet counter 516 set to x and expected sequence number 518 set to “1”, which does not match the respective packet number (such as packet number x+3) or sequence number (such as sequence number “0”) associated with the nonce used by the source device 550 to encrypt the fifth packet 562e.

If the decryption component 514 is configured with the two nonces 520a, 520b, then the decryption component 514 may determine that the sequence number “0” included in the third packet 562c does not match the expected sequence number 518 of “1” and the decryption component 514 may select the second nonce 520b corresponding to the next expected sequence number “0” and next expected packet number x+1. While the sequence numbers associated with the second nonce 520b may match, the packet numbers do not and, therefore, the decryption component 514 may determine that the fifth packet 562e is unsuccessfully decrypted. In response, the decryption component 514 may realign the packet counter 516 with that of the source device 550 by setting the packet counter 516 to x+4, which may be the next expected packet number. Further, the decryption component 514 may set the expected sequence number 518 to “1”.

According to the fourth example, if the decryption component 514 is configured with only one nonce, the packet counter 516 may become too unaligned for the decryption component 514 to recover from after three missed packets. Similarly, if the decryption component 514 is configured with two nonces, the packet counter 516 may become too unaligned for the decryption component 514 to recover from after four consecutive missed packets. In which case, the secondary device 504 may wait to synchronize with the primary device 502 over the other communications link 554. In synchronizing with the primary device 502, the secondary device 504 may receive information that allows the decryption component 514 to realign the packet counter 516 of the secondary device 504 with that of the source device 550, and resume successfully decrypting packets from the source device 550.

Illustratively, Table 1 shows the preceding examples when the decryption component 514 is configured with one nonce. Table 2 shows the preceding examples when the decryption component 514 is configured with two nonces. In Tables 1 and 2, the packet counter 516 is set to x and the expected sequence number 518 is set to “1”. Further, Tables 1 and 2 assume that the CRC/MIC octets of the received packet do not match the stored CRC/MIC octets of the previously received packet. If the CRC/MIC octets of the received packet match the stored CRC/MIC octets of the previously received packet, then the received packet is a retransmission of a previous packet and the packet counter 516 and expected sequence number 518 remain unchanged.

In Tables 1 through 4, the “SEQN” column indicates the sequence number included in a received packet. The “CRC Validation” column indicates whether the received packet passes CRC validation by the CRC component. The “Decryption Successful” column indicates whether the decryption component 514 successfully decrypts the received packet. The “Received Packet” column indicates the sequence number and packet number respectively determined by the decryption component 514 for the received packet. The “Next Expected Packet” column indicates the sequence number and packet number respectively determined by the decryption component 514 for the next packet—for example, the sequence number to which the expected sequence number 518 is to be set and the packet number to which the packet counter 516 is to be set in order to realign with the source device 550.

TABLE 1

| | CRC | Decryption | Received | Next Expected |
|---|---|---|---|---|
| SEQN | Validation | Successful | Packet | Packet |
| 0 | Pass | Fail | SEQN: 0 | SEQN: 1 |
| | | | Packet: x + 1 | Packet: x + 2 |
| 1 | Pass | Fail | SEQN: 1 | SEQN: 0 |
| | | | Packet: x + 2 | Packet: x + 3 |
| 0 | Pass | Pass | N/A | N/A |
| 1 | Pass | Pass | SEQN: 1 | SEQN: 0 |
| | | | Packet: x | Packet: x + 1 |
| 0 or 1 | Fail | N/A | N/A | SEQN: 1 |
| | | | | Packet: x |

TABLE 2

| Received | CRC | Decryption | Received | Next Expected |
|---|---|---|---|---|
| SEQN | Validation | Successful | Packet | Packet |
| 0 | Pass | Fail | SEQN: 0 | SEQN: 1 |
| | | | Packet: x + 3 | Packet: x + 4 |
| 1 | Pass | Fail | SEQN: 1 | SEQN: 0 |
| | | | Packet: x + 2 | Packet: x + 3 |
| 0 | Pass | Pass | SEQN: 0 | SEQN: 1 |
| | | | Packet: x + 1 | Packet: x + 2 |
| 1 | Pass | Pass | SEQN: 1 | SEQN: 0 |
| | | | Packet: x | Packet: x + 1 |
| 0 or 1 | Fail | N/A | N/A | SEQN: 1 |
| | | | | Packet: x |

In some situations, the sequence number included in a packet may become corrupted during over the air transmission and/or may be incorrectly decoded by the secondary device 504. For example, a packet associated with a sequence number “0” may be provided to the decryption component 514 with a sequence number “1”, or vice versa. Thus, the packet counter 516 of the secondary device 504 may still be aligned with that of the source device 550. In one configuration, the secondary device 504 may determine that the sequence number of a packet has been flipped and may set the expected sequence number 518 based on the flipped sequence number.

Illustratively, Table 3 shows various examples when the decryption component 514 is configured with one nonce and the decryption component 514 determines that the sequence number is flipped. Table 4 shows various examples when the decryption component 514 is configured with two nonces and the decryption component 514 determines that the sequence number is flipped. In Tables 3 and 4, the packet counter 516 is set to x and the expected sequence number 518 is set to “1”. Further, Tables 3 and 4 assume that the CRC/MIC octets of the received packet do not match the stored CRC/MIC octets of the previously received packet (if the CRC/MIC octets of the received packet match the stored octets of the previously received packet, then the received packet is a retransmission of a previous packet and the packet counter 516 and expected sequence number 518 remain unchanged). Note that the expected received packet, and the next expected packet to which the expected sequence number 518 and packet counter 516 are to be respectively set in order to realign with the source device 550 may not necessarily change from Tables 1 and 2.

TABLE 3

| Received | CRC | Decryption | Received | Next Expected |
|---|---|---|---|---|
| SEQN | Validation | Successful | Packet | Packet |
| 0 | Pass | Fail | SEQN: 0 | SEQN: 1 |
| | | | Packet: x + 1 | Packet: x + 2 |
| 1 | Pass | Fail | SEQN: 0 | SEQN: 1 |
| | | | Packet: x + 1 | Packet: x + 2 |
| 0 | Pass | Pass | SEQN: 1 | SEQN: 0 |
| | | | Packet: x | Packet: x + 1 |
| 1 | Pass | Pass | SEQN: 1 | SEQN: 0 |
| | | | Packet: x | Packet: x + 1 |
| 0 or 1 | Fail | N/A | N/A | SEQN: 1 |
| | | | | Packet: x |

TABLE 4

| Received | CRC | Decryption | Received | Next Expected |
|---|---|---|---|---|
| SEQN | Validation | Successful | Packet | Packet |
| 0 | Pass | Fail | SEQN: 1 | SEQN: 0 |
| | | | Packet: x | Packet: x + 1 |
| 1 | Pass | Fail | SEQN: 0 | SEQN: 1 |
| | | | Packet: x + 1 | Packet: x + 2 |
| 0 | Pass | Pass | SEQN: 0 | SEQN: 1 |
| | | | Packet: x + 1 | Packet: x + 2 |
| 1 | Pass | Pass | SEQN: 1 | SEQN: 0 |
| | | | Packet: x | Packet: x + 1 |
| 0 or 1 | Fail | N/A | N/A | SEQN: 1 |
| | | | | Packet: x |

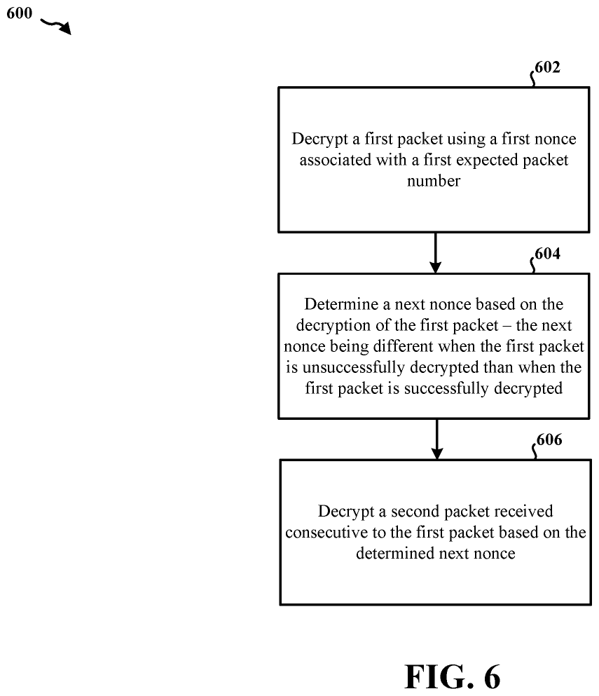

FIG. 6 is a flowchart of a method 600 of wireless communication. The method 600 may be performed by a first device, such as the headset 112, the secondary earpiece 114b, the wireless device 200, the secondary device 504, and/or the apparatus 802/802′, which may receive transmissions from a second device, such as the wireless device 102, the wireless device 200, the source device 550, and/or the source device 850. In different aspects, one or more illustrated operations may be omitted, transposed, and/or contemporaneously performed.

Beginning with operation 602, the first device may decrypt a first packet using a first nonce associated with the first expected packet number. For example, the first device may generate a first nonce based on a first expected sequence number and based on a first expected packet number. Next, the first device may apply a decryption function to the first packet using the first nonce. The first device may obtain a decrypted first packet based on applying the decryption function to the first packet using the first nonce. The first device may identify a MIC included in the decrypted first packet, and the MIC may be used to determine whether the first device successfully decrypted the first packet.

For example, referring to FIG. 5, the decryption component 514 of the secondary device 504 may decrypt one of the received packets 562a, 562b, 562c, 562d using the first nonce 520a or, if the decryption component 514 is configured with two nonces, using one of the first nonce 520a or the second nonce 520b. For example, the decryption component 514 may generate the first nonce 520a based on the expected sequence number 518 and based on the expected packet number to which the packet counter 516 is set. If the decryption component 514 is configured with two nonces, the decryption component 514 may generate the second nonce 520b based on a different sequence number than the expected sequence number 518 and based on the next expected packet number consecutive to the expected packet number to which the packet counter 516 is set. Next, the decryption component 514 may apply a decryption function to the one of the received packets 562a, 562b, 562c, 562d using the first nonce 520a or, if the decryption component 514 is configured with two nonces, using one of the first nonce 520a or the second nonce 520b. The decryption component 514 may obtain a decrypted one of the received packets 562a, 562b, 562c, 562d based on applying the decryption function to the one of the received packets 562a, 562b, 562c, 562d using the first nonce 520a or, potentially, the second nonce 520b. The decryption component 514 may identify a MIC included in the decrypted one of the received packets 562a, 562b, 562c, 562d, and the MIC may be used to determine whether the decryption component 514 successfully decrypted the one of the received packets 562a, 562b, 562c, 562d.

At operation 604, the first device may determine a next nonce based on the decryption of the first packet, and the next nonce may be different when the first packet is unsuccessfully decrypted than when the first packet is successfully decrypted. For example, when the first packet is successfully decrypted, then the first device may determine the next nonce is associated with a next expected packet number and a next expected sequence number. Illustratively, when the first packet is successfully decrypted using a first nonce associated with an expected packet number x−1 and associated with an expected sequence number s′, then the first device may determine that the next nonce is associated with a next expected packet number x and associated with a next expected sequence number s. The first device may generate the next nonce based on the next expected packet number x and based on the next expected sequence number s. If the first device is configured with two nonces and the second nonce is used to successfully decrypt the packet, then the first device may generate the next nonce based on the packet number x+2 that is consecutive to the next expected packet number x+1, and based on the sequence number s′. The second nonce used by the first device to successfully decrypt the first packet may be associated with the packet number x+1 that is consecutive to the next expected packet number x and further associated with an expected sequence number s′.

Illustratively, the first device may receive a previous packet, and the first device may successfully decode the previous packet using a previous nonce associated with a previous expected packet number x−1 and a previous expected sequence number s′. Therefore, the first device may set a packet counter to the expected packet number x, and the first device may set an expected sequence number to s. The first device may receive and decrypt the received first packet using a first nonce associated with the expected packet number x and the expected sequence number s. Alternatively, the first device may decrypt the received packet using a second nonce associated with the next expected packet number x+1 and the next expected sequence number s′, for example, if the first packet includes a sequence number s′.

According to a first example, the first device may receive the first packet including the sequence number s′, which may be different from the expected sequence number s. The first device may determine that the first packet is unsuccessfully decrypted (that is, the first packet fails MIC validation). The first device may first determine whether the first packet is a retransmission of the previous packet, such as, by comparing a first set of octets associated with at least one of a first CRC value and/or a first MIC included in the first packet to a stored set of octets associated with at least one of a previous CRC value and/or a previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the first example, if the first packet is not a retransmission of the previous packet (for example, if the first set of octets do not match the stored set of octets), then the first device may determine a next nonce that is different from another nonce that would be used if the first packet was successfully decrypted. For example, the other nonce may have been generated based on the next expected packet number x+1 and next expected sequence number s′ if a first nonce is used for successful decryption, or the other nonce may have been generated based on the expected packet number x+2 and the expected sequence numbers if the first device is configured with the second nonce and the second nonce is used for successful decryption. If the first device is configured with one nonce, the first device may determine that the first packet is associated with packet number x+1 and sequence number s′. Therefore, the first device may set the packet counter to x+2 and the expected sequence number to s. The first device may generate the next nonce based on the packet counter of x+2 and the expected sequence number of s.

Further to the first example, in one configuration, the first device may determine that the first packet is associated with packet number x+3 and sequence number s′ if the first device is configured with two nonces. In this configuration, the first device may set the packet counter to x+4 and the expected sequence number to s. The first device may generate the next nonce based on the packet counter of x+4 and the expected sequence number of s. According to an alternative configuration, the first device may be configured to determine the next nonce based on a sequence number flip. A sequence number flip may occur when the sequence number included in the first packet may become corrupted and/or may be incorrectly decoded as one of s or s′ when the first packet was encrypted with a nonce based on the other one of s′ or s. Therefore, the first device may determine the first packet is associated with packet number x and sequence number s, even though the first packet includes a sequence number of s′. In this alternative configuration, the first device may attempt to realign the packet counter of the first device with that of the second device by setting the packet counter to packet number x+1. Further, the first device may set the expected sequence number to s′. Thus, the first device may determine and/or generate a next first nonce to be used for decrypting the next packet based on the packet counter of x+1, and based on the expected sequence number of s′. Further, the first device may determine and/or generate a next second nonce to be used for decrypting the next packet based on the next expected packet number of x+2, and based on the next expected sequence number of s.

According to a second example, the first device may receive a first packet including a sequence number of s, which may match the expected sequence number of s. The first device may determine that the first packet is unsuccessfully decrypted and/or fails MIC validation. The first device may first determine whether the first packet is a retransmission of the previous packet, such as by comparing a first set of octets associated with at least one of a first CRC value and/or a first MIC included in the first packet to a stored set of octets associated with at least one of a previous CRC value and/or a previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the second example, if the first packet is not a retransmission of the previous packet (for example, if the first set of octets do not match the stored set of octets), then the first device may determine a next nonce that is different from another nonce that would be used if the first packet was successfully decrypted. For example, the other nonce may have been generated based on the next expected packet number x+1 and next expected sequence number s′ if a first nonce is used for successful decryption, or the other nonce may have been generated based on the expected packet number x+2 and the expected sequence numbers if the first device is configured with the second nonce and the second nonce is used for successful decryption of the first packet. In both cases in which the first device is configured with one nonce or configured with two nonces, the first device may determine that the first packet is associated with packet number x+2 and sequence numbers. Therefore, the first device may set the packet counter to x+3 and the expected sequence number to s′. The first device may generate the next nonce based on the packet counter of x+3 and the expected sequence number of s′.

Further to the second example, in an alternative configuration applicable to both the first device being configured with one nonce and being configured with two nonces, the first device may be configured to determine the next nonce based on a sequence number flip. Therefore, the first device may determine the first packet is associated with packet number x+1 and sequence number s′, even though the first packet includes a sequence number of s. In this alternative configuration, the first device may attempt to realign the packet counter of the first device with that of the second device by setting the packet counter to packet number x+2. Further, the first device may set the expected sequence number to s. Thus, the first device may determine and/or generate a next first nonce to be used for decrypting the next packet based on the packet counter of x+2, and based on the expected sequence number of s. If the first device is configured with two nonces, the first device may determine and/or generate a next second nonce to be used for decrypting the next packet based on the next expected packet number of x+3, and based on the next expected sequence number of s′.

According to a third example, the first device may receive the first packet including the sequence numbers', which may be different from the expected sequence number s. However, the first device may determine that the first packet is successfully decrypted and/or passes MIC validation. The first device may first determine whether the first packet is a retransmission of the previous packet, such as by comparing a first set of octets associated with at least one of a first CRC value and/or a first MIC included in the first packet to a stored set of octets associated with a previous CRC value and/or previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the third example, if the first packet is not a retransmission of the previous packet, then the first device may determine a next nonce that is different from another nonce that would be used if the first packet was successfully decrypted. If the first device is configured with two nonces, the first device may determine that the first packet is associated with packet number x+1 and sequence number s′. Accordingly, the first device may set the packet counter to be aligned with that of the second device by setting the packet counter to x+2 and the expected sequence number to s.

Further to the third example, in an alternative configuration, the first device may be configured to determine the next nonce based on a sequence number flip. When the first device is configured with one nonce, the first device may determine the first packet is associated with packet number x and sequence number s, even though the first packet includes a sequence number of s′. In this alternative configuration, the first device may align the packet counter of the first device with that of the second device by setting the packet counter to packet number x+1. Further, the first device may set the expected sequence number to s′. Thus, the first device may determine and/or generate a next first nonce to be used for decrypting the next packet based on the packet counter of x+1, and based on the expected sequence number of s′. Note that this third example may not occur when the first device is configured with one nonce, and the third example may not occur with a sequence flip when the first device is configured with two nonces.

For example, referring to FIG. 5, the decryption component 514 of the secondary device 504 may determine a next nonce to be used for decryption of a next received packet, such as a next one of the received packets 562b, 562c, 562d, 562e, based on the decryption of the one of the received packets 562a, 562b, 562c, 562d, and the decryption component 514 may determine that the next nonce is different when the one of the received packets 562a, 562b, 562c, 562d is unsuccessfully decrypted than when the one of the received packets 562a, 562b, 562c, 562d is successfully decrypted. For example, the decryption component 514 may determine a packet number and a sequence number corresponding to the one of the received packets 562a, 562b, 562c, 562d. The decryption component 514 may then determine a next packet number and a next sequence number expected to correspond to the next one of the received packets 562b, 562c, 562d, 562e. The decryption component 514 may set the packet counter 516 to a next expected packet number based on the packet number determined to correspond to the one of the received packets 562a, 562b, 562c, 562d. Further, the decryption component 514 may set the expected sequence number to a next expected sequence number based on the sequence number determined to correspond to the one of the received packets 562a, 562b, 562c, 562d. The decryption component 514 may then determine and/or generate the first nonce 520a to be used for decryption of the next one of the received packets 562b, 562c, 562d, 562e based on the packet counter 516 being set to the next expected packet number and the expected sequence number 518 being set to next expected sequence number. If the decryption component 514 is configured with two nonces, the decryption component 514 may then determine and/or generate the second nonce 520b to be used for decryption of the next one of the received packets 562b, 562c, 562d, 562e based on the next consecutive increment of the packet counter 516 that is set to the next expected packet number, and further based on the other sequence number different from the next expected sequence number, which may be s′ if the next expected sequence number is s or s if the next expected sequence number is s′. Various examples are illustrated with respect to FIG. 5 at Tables 1 through 4, supra.

At operation 606, the first device may decrypt a second packet based on the determined next nonce. For example, if the first device is configured with one nonce, then the first device may decrypt the second packet using the next nonce. If the first device is configured with two nonces, the first device may determine to use the next nonce instead of a second next nonce based on a next expected sequence number associated with the next nonce. For example, the first device may detect a sequence number included in the second packet. The first device may compare the detected sequence number included in the second packet to the next expected sequence number associated with the next nonce. Further, the first device may compare the detected sequence number included in the first packet to a second next expected sequence number associated with the second next nonce. The first device may select the next nonce instead of the second next nonce when the detected sequence number included in the second packet matches the next expected sequence number associated with the next nonce. Otherwise, the first device may select the second next nonce that is associated with the next consecutive packet number following the next expected packet number to which the packet counter is set and associated with the other sequence number that is different from the next expected sequence number.

According to various aspects, the first device may generate the next nonce based on a decryption function that takes a set of inputs, and at least one of the inputs may be the next expected packet number to which the packet counter is set. Further, the decryption function may take the next expected sequence number as another of the set of inputs. The first device may load the next nonce into the memory to be used when applying the decryption function. The first device may then apply the decryption function to the second packet using the next nonce that is generated based on the next expected packet number and the next expected sequence number.

If configured with two nonces, the first device may further determine the second next nonce. For example, the first device may generate the second next nonce based on the aforementioned decryption function, although the at least one of the inputs may be consecutive to the next expected packet number of the packet counter, and another one of the inputs may be the other sequence number different from the next expected sequence number. As with the next nonce, the first device may load the second next nonce into the memory to be used when applying the decryption function. The first device may then determine whether to use the next nonce or the second next nonce based on whether the sequence number included in the second packet matches the next expected sequence number (associated with the next nonce) or matches the other sequence number different from the expected sequence number.

For example, referring to FIG. 5, the decryption component 514 of the secondary device 504 may decrypt a next one of the received packets 562b, 562c, 562d, 562eusing the next first nonce 520a or, if the decryption component 514 is configured with two nonces, using one of the next first nonce 520a or the next second nonce 520b. For example, the decryption component 514 may generate the next first nonce 520a based on the next expected sequence number 518 and based on the next expected packet number to which the packet counter 516 is set. If the decryption component 514 is configured with two nonces, the decryption component 514 may generate the next second nonce 520b based on a different sequence number than the expected sequence number 518 and based on a packet number that is consecutive to the next expected packet number to which the packet counter 516 is set. Next, the decryption component 514 may apply a decryption function to the next one of the received packets 562b, 562c, 562d, 562e using the next first nonce 520a or, if the decryption component 514 is configured with two nonces, using one of the next first nonce 520a or the next second nonce 520b. The decryption component 514 may obtain a decrypted next one of the received packets 562b, 562c, 562d, 562e based on applying the decryption function to the next one of the received packets 562b, 562c, 562d, 562e using the next first nonce 520a or, if applicable, using the next second nonce 520b. The decryption component 514 may identify a MIC included in the decrypted next one of the received packets 562b, 562c, 562d, 562e, and the MIC may be used to determine whether the decryption component 514 successfully decrypted the next one of the received packets 562b, 562c, 562d, 562e.

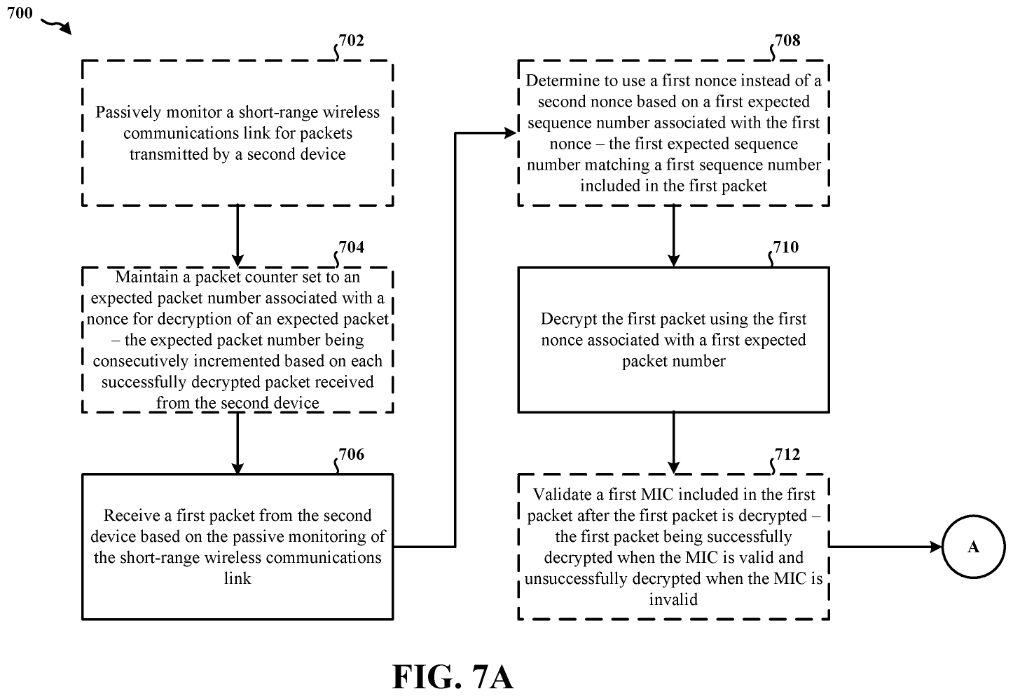

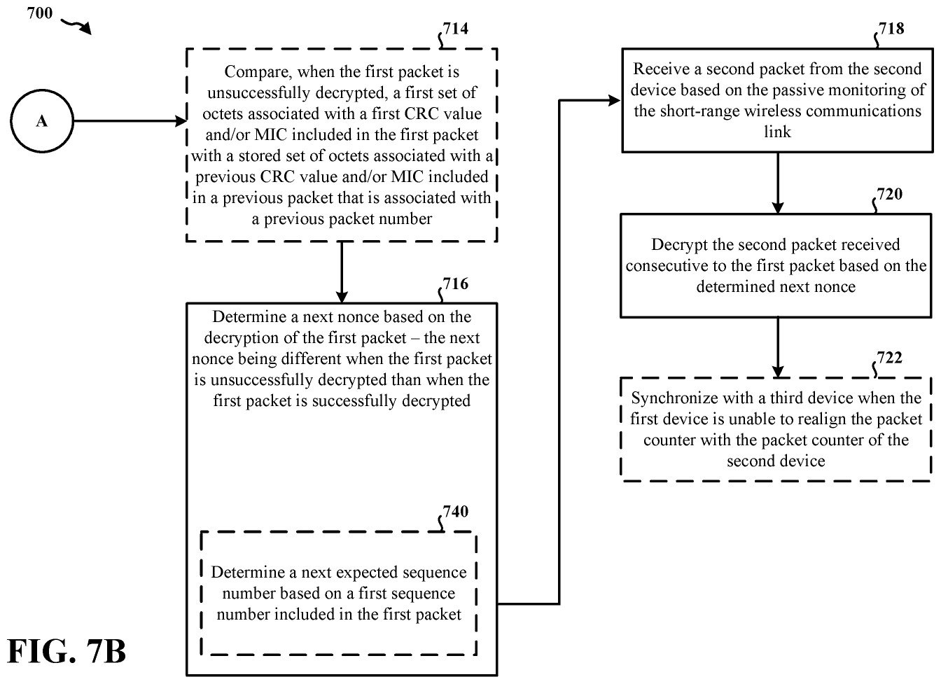

FIGS. 7A and 7B are a flowchart of a method 700 of setting a packet counter in a short-range wireless communications system. The method 700 may be performed by a first device, such as the headset 112, the secondary earpiece 114b, the wireless device 200, the secondary device 504, and/or the apparatus 802/802′, which may receive transmissions from a second device, such as the wireless device 102, the wireless device 200, the source device 550, and/or the source device 850. In different aspects, one or more illustrated operations may be omitted, transposed, and/or contemporaneously performed.

Referring to FIG. 7A, at operation 702, the first device may passively monitor a short-range wireless communications link for packets transmitted by a second device. For example, the first device may detect for signals on one or more resources of a frequency band associated with short-range wireless communications. When the first device detects a signal on the one or more resources of the frequency band, the first device may determine whether the detected signal includes a packet that is decodable by the first device, such as by identifying one or more header fields that include one or more values indicating the packet includes a payload that is decodable by the first device—examples of the one or more values may include an access address field, an LT_ADDR field, etc. In one aspect, the packets detected on the short-range wireless communications link may be encrypted based on an AES-CCM mode.

For example, referring to FIG. 5, the secondary device 504 may passively monitor the communications link 552 established between the primary device 502 and the source device 550. The secondary device 504 may detect for signals on one or more resources of a frequency band associated with the communications link 552, and the secondary device 504 may determine whether a detected signal includes a packet of the set of packets 560 that is decodable by the secondary device 504, such as by identifying whether one or more header fields of a packet of the set of packets 560 includes one or more values indicating the packet is addressed to the primary device 502—examples of the one or more values may include an access address field or an LT_ADDR field. The secondary device 504 may further determine that each of the set of packets 560 detected on the communications link 552 may be encrypted based on an AES-CCM mode.

At operation 704, the first device may maintain a packet counter set to an expected packet number associated with a nonce for decryption of an expected packet. In one aspect, the packet counter may be consecutively incremented to the expected packet number based on each successfully decrypted packet received from the second device over the short-range wireless communications link. For example, the first device may set a packet counter to an initial value x. When the first device receives a packet over the short-range wireless communications link, the first device may decrypt the packet. When the first packet is successfully decrypted, the first device may consecutively increment (that is, add a “1”) to the initial value x. If the first packet is unsuccessfully decrypted, the first device may determine the expected packet number to which the packet counter is to be set—for example, the first device may determine a value nonconsecutive to the initial value x or the consecutive increment to the initial value x.

For example, referring to FIG. 5, the decryption component 514 of the secondary device 504 maintain the packet counter 516. When the decryption component 514 successfully decrypts the first packet 562a (associated with packet number x−1), then the decryption component 514 may consecutively increment the packet counter 516—for example, the packet counter 516 may be consecutively incremented to x from the packet number x−1. The decryption component 514 may miss the second and third packets 562b, 562c, and may unsuccessfully decrypt the fourth packet 562d (associated with packet number x+2). Based on the unsuccessful decryption of the fourth packet 562d, the decryption component 514 may determine the expected packet number to which the packet counter 516 is to be set—for example, the decryption component 514 may set the packet counter 516 to x+3 based on determining that the fourth packet 562d is associated with a packet number x+2.

At operation 706, the first device may receive a first packet from the second device based on the passive monitoring of the short-range wireless communications link. For example, the first device may detect a packet over the short-range wireless communications link, and the first device may determine whether the detected packet is decodable by the first device.

For example, referring to FIG. 5, the secondary device 504 may receive one of the first packet 562a, the second packet 562b, the third packet 562c, or the fourth packet 562d of the set of packets 560. The secondary device 504 may detect a packet transmitted over the communications link 552, and the secondary device 504 may determine whether the packet is intended for the primary device 502, with which the secondary device 504 may be associated.

At operation 708, if the first device is configured with two nonces, the first device may determine to use a first nonce instead of a second nonce based on a first expected sequence number associated with the first nonce. For example, the first device may detect a sequence number included in the first packet. The first device may compare the detected sequence number included in the first packet to the first expected sequence number associated with the first nonce. Further, the first device may compare the detected sequence number included in the first packet to a second expected sequence number associated with the second nonce. The first device may select the first nonce instead of the second nonce when the detected sequence number included in the first packet matches the first expected sequence number associated with the first nonce.

For example, referring to FIG. 5, the decryption component 514 of the secondary device 504 may be configured with two nonces 520a, 520b. The first nonce 520a may be associated with the expected sequence number 518 (such as one of two values to which the sequence number may be set, and the second nonce 520b may be associated with a next expected sequence number (such as the other of the two values to which the sequence number may be set). The decryption component 514 may identify the sequence number included in the one of the received packets 562a, 562b, 562c, 562d. The decryption component 514 may compare the identified sequence number with the expected sequence number 518. If the identified sequence number matches the expected sequence number 518, then the decryption component 514 may determine to use the first nonce 520a. If the identified sequence number does not match the expected sequence number 518, then the decryption component 514 may determine to use the second nonce 520b.

At operation 710, the first device may decrypt the first packet using the first nonce associated with the first expected packet number. For example, the first device may generate the first nonce based on a first expected sequence number and based on the first expected packet number. Next, the first device may apply a decryption function to the first packet using the first nonce. The first device may obtain a decrypted first packet based on applying the decryption function to the first packet using the first nonce. The first device may identify a MIC included in the decrypted first packet, and the MIC may be used to determine whether the first device successfully decrypted the first packet.

For example, referring to FIG. 5, the decryption component 514 of the secondary device 504 may decrypt the one of the received packets 562a, 562b, 562c, 562d using the first nonce 520a or, if the decryption component 514 is configured with two nonces, using the determined one of the first nonce 520a or the second nonce 520b. For example, the decryption component 514 may generate the first nonce 520a based on the expected sequence number 518 and based on the expected packet number to which the packet counter 516 is set. If the decryption component 514 is configured with two nonces, the decryption component 514 may generate the second nonce 520b based on a different sequence number than the expected sequence number 518 and based on the next expected packet number consecutive to the expected packet number to which the packet counter 516 is set. Next, the decryption component 514 may apply a decryption function to the one of the received packets 562a, 562b, 562c, 562d using the first nonce 520a or, if the decryption component 514 is configured with two nonces, using the determined one of the first nonce 520a or the second nonce 520b. The decryption component 514 may obtain a decrypted one of the received packets 562a, 562b, 562c, 562d based on applying the decryption function to the one of the received packets 562a, 562b, 562c, 562d using the first nonce 520a or, potentially, the second nonce 520b. The decryption component 514 may identify a MIC included in the decrypted one of the received packets 562a, 562b, 562c, 562d, and the MIC may be used to determine whether the decryption component 514 successfully decrypted the one of the received packets 562a, 562b, 562c, 562d.

At operation 712, the first device may validate a MIC included in the first packet after the first packet is decrypted, and the first device may determine that the first packet is successfully decrypted if the MIC is valid and the first device may determine that the first packet is unsuccessfully decrypted if the MIC is invalid. For example, the first device may generate an expected MIC based on the decrypted first packet. The first device may compare the expected MIC to the MIC included in the first packet. The first device may determine that the MIC is valid and the first packet is successfully decrypted when the expected MIC matches the MIC included in the first packet, and the first device may determine that the MIC is invalid and the first packet is unsuccessfully decrypted when the expected MIC does not match the MIC included in the first packet.

For example, referring to FIG. 5, the decryption component 514 of the secondary device 504 may validate a first MIC included in the one of the received packets 562a, 562b, 562c, 562d. The decryption component 514 may generate an expected MIC based on the decrypted one of the received packets 562a, 562b, 562c, 562d. The decryption component 514 may compare the expected MIC to the MIC included in the decrypted one of the received packets 562a, 562b, 562c, 562d. The decryption component 514 may determine that the one of the received packets 562a, 562b, 562c, 562d is successfully decrypted when the expected MIC matches the MIC included in the decrypted one of the received packets 562a, 562b, 562c, 562d, and the decryption component 514 may determine that the one of the received packets 562a, 562b, 562c, 562d is unsuccessfully decrypted when the expected MIC does not match the MIC included in the one of the received packets 562a, 562b, 562c, 562d.

At operation 714, when the first packet is unsuccessfully decrypted, the first device may compare a first set of octets associated with at least one of a first CRC value and/or a first MIC included in the first packet to a stored set of octets associated with at least one of a previous CRC value and/or a previous MIC included in a previous packet that is associated with a previous packet number. The previous packet may be the most-recently received packet. For example, the first device may generate a first CRC value and/or a first MIC based on a received first packet, and the first device may store the first CRC value and/or first MIC. When the first device receives a next packet, the first device may generate a second CRC value and/or second MIC based on the next packet. When the first device unsuccessfully decrypts the next packet, the first device may compare the second CRC value with the stored first CRC value and/or may compare the second MIC with the stored first MIC. The first device may determine that the next packet is a retransmission of the first packet when the second CRC value matches the stored first CRC value and/or when the second MIC matches the stored first MIC. The first device may determine that the next packet is not a retransmission of the first packet when the second CRC value does not match the stored first CRC value and/or when the second MIC does not match the stored first MIC.

For example, referring to FIG. 5, when the decryption component 514 of the secondary device 504 unsuccessfully decrypts the one of the received packets 562a, 562b, 562c, 562d, the decryption component 514 may compare a first set of octets associated with the CRC value or MIC of the one of the received packets 562a, 562b, 562c, 562d to a stored set of octets associated with previous CRC value or previous MIC of a previously received one of the first packet 562a, second packet 562b, or third packet 562c. The decryption component 514 may determine that the one of the received packets 562a, 562b, 562c, 562d is a retransmission of a previous one of the received packets 562a, 562b, 562c when the first set of octets associated with the CRC value or MIC matches the stored set of octets associated with the previous CRC value or previous MIC, respectively. The decryption component 514 may determine that the one of the received packets 562a, 562b, 562c, 562d is not a retransmission of a previous one of the received packets 562a, 562b, 562c when the first set of octets associated with the CRC value or MIC of the one of the received packets 562a, 562b, 562c, 562d does not match the stored set of octets associated with the previous CRC value or MIC, respectively, of the previous one of the received packets 562a, 562b, 562c.

At operation 716, the first device may determine a next nonce based on the decryption of the first packet, and the next nonce may be different when the first packet is unsuccessfully decrypted than when the first packet is successfully decrypted. For example, when the first packet is successfully decrypted, then the first device may determine the next nonce is associated with a next expected packet number and a next expected sequence number. Illustratively, when the first packet is successfully decrypted using a first nonce associated with an expected packet number x−1 and associated with an expected sequence number s′, then the first device may determine that the next nonce is associated with a next expected packet number x and associated with a next expected sequence number s. The first device may generate the next nonce based on the next expected packet number x and based on the next expected sequence number s. If the first device is configured with two nonces and the second nonce is used to successfully decrypt the packet, then the first device may generate the next nonce based on the packet number x+2 that is consecutive to the next expected packet number x+1, and based on the sequence number s′. The second nonce used by the first device to successfully decrypt the first packet may be associated with the packet number x+1 that is consecutive to the next expected packet number x and further associated with an expected sequence number s′.

Illustratively, the first device may receive a previous packet, and the first device may successfully decode the previous packet using a previous nonce associated with a previous expected packet number x−1 and a previous expected sequence number s′. Therefore, the first device may set a packet counter to the expected packet number x, and the first device may set an expected sequence number to s. The first device may receive and decrypt the received first packet using a first nonce associated with the expected packet number x and the expected sequence number s. Alternatively, the first device may decrypt the received packet using a second nonce associated with the next expected packet number x+1 and the next expected sequence number s′, for example, if the first packet includes a sequence number s′.

According to a first example, the first device may receive the first packet including the sequence number s′, which may be different from the expected sequence number s. The first device may determine that the first packet is unsuccessfully decrypted. The first device may first determine whether the first packet is a retransmission of the previous packet, such as, by comparing a first set of octets associated with at least one of a first CRC value and/or a first MIC included in the first packet to a stored set of octets associated with at least one of a previous CRC value and/or a previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the first example, if the first packet is not a retransmission of the previous packet (for example, if the first set of octets do not match the stored set of octets), then the first device may determine a next nonce that is different from another nonce that would be used if the first packet was successfully decrypted. For example, the other nonce may have been generated based on the next expected packet number x+1 and next expected sequence number s′ if a first nonce is used for successful decryption, or the other nonce may have been generated based on the expected packet number x+2 and the expected sequence numbers if the first device is configured with the second nonce and the second nonce is used for successful decryption. If the first device is configured with one nonce, the first device may determine that the first packet is associated with packet number x+1 and sequence number s′. Therefore, the first device may set the packet counter to x+2 and the expected sequence number to s. The first device may generate the next nonce based on the packet counter of x+2 and the expected sequence number of s.

Further to the first example, in one configuration, the first device may determine that the first packet is associated with packet number x+3 and sequence number s′ if the first device is configured with two nonces. In this configuration, the first device may set the packet counter to x+4 and the expected sequence number to s. The first device may generate the next nonce based on the packet counter of x+4 and the expected sequence number of s. According to an alternative configuration, the first device may be configured to determine the next nonce based on a sequence number flip. A sequence number flip may occur when the sequence number included in the first packet may become corrupted and/or may be incorrectly decoded as one of s or s′ when the first packet was encrypted with a nonce based on the other one of s′ or s. Therefore, the first device may determine the first packet is associated with packet number x and sequence number s, even though the first packet includes a sequence number of s′. In this alternative configuration, the first device may attempt to realign the packet counter of the first device with that of the second device by setting the packet counter to packet number x+1. Further, the first device may set the expected sequence number to s′. Thus, the first device may determine and/or generate a next first nonce to be used for decrypting the next packet based on the packet counter of x+1, and based on the expected sequence number of s′. Further, the first device may determine and/or generate a next second nonce to be used for decrypting the next packet based on the next expected packet number of x+2, and based on the next expected sequence number of s.

According to a second example, the first device may receive a first packet including a sequence number of s, which may match the expected sequence number of s. The first device may determine that the first packet is unsuccessfully decrypted and/or fails MIC validation. The first device may first determine whether the first packet is a retransmission of the previous packet, such as by comparing a first set of octets associated with at least one of a first CRC value and/or a first MIC included in the first packet to a stored set of octets associated with at least one of a previous CRC value and/or a previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the second example, if the first packet is not a retransmission of the previous packet (for example, if the first set of octets do not match the stored set of octets), then the first device may determine a next nonce that is different from another nonce that would be used if the first packet was successfully decrypted. For example, the other nonce may have been generated based on the next expected packet number x+1 and next expected sequence number s′ if a first nonce is used for successful decryption, or the other nonce may have been generated based on the expected packet number x+2 and the expected sequence numbers if the first device is configured with the second nonce and the second nonce is used for successful decryption of the first packet. In both cases in which the first device is configured with one nonce or configured with two nonces, the first device may determine that the first packet is associated with packet number x+2 and sequence numbers. Therefore, the first device may set the packet counter to x+3 and the expected sequence number to s′. The first device may generate the next nonce based on the packet counter of x+3 and the expected sequence number of s′.

Further to the second example, in an alternative configuration applicable to both the first device being configured with one nonce and being configured with two nonces, the first device may be configured to determine the next nonce based on a sequence number flip. Therefore, the first device may determine the first packet is associated with packet number x+1 and sequence number s′, even though the first packet includes a sequence number of s. In this alternative configuration, the first device may attempt to realign the packet counter of the first device with that of the second device by setting the packet counter to packet number x+2. Further, the first device may set the expected sequence number to s. Thus, the first device may determine and/or generate a next first nonce to be used for decrypting the next packet based on the packet counter of x+2, and based on the expected sequence number of s. If the first device is configured with two nonces, the first device may determine and/or generate a next second nonce to be used for decrypting the next packet based on the next expected packet number of x+3, and based on the next expected sequence number of s′.

According to a third example, the first device may receive the first packet including the sequence number s′, which may be different from the expected sequence number s. However, the first device may determine that the first packet is successfully decrypted and/or passes MIC validation. The first device may first determine whether the first packet is a retransmission of the previous packet, such as by comparing a first set of octets associated with at least one of a first CRC value and/or a first MIC included in the first packet to a stored set of octets associated with a previous CRC value and/or previous MIC included in the previous packet. When the first set of octets match the stored set of octets, then the first device may determine that the first packet is a retransmission of the previous packet. Therefore, the first device may leave the expected packet number and expected sequence number unchanged. Accordingly, the first device may determine that the next nonce is the same as the first nonce. If the first device is configured with two nonces, then the first device may further determine that the second next nonce is the same as the second nonce—that is, the second next nonce is associated with the next expected packet number x+1 and the next expected sequence number s′.

Further to the third example, if the first packet is not a retransmission of the previous packet, then the first device may determine a next nonce that is different from another nonce that would be used if the first packet was successfully decrypted. If the first device is configured with two nonces, the first device may determine that the first packet is associated with packet number x+1 and sequence number s′. Accordingly, the first device may set the packet counter to be aligned with that of the second device by setting the packet counter to x+2 and the expected sequence number to s.

Further to the third example, in an alternative configuration, the first device may be configured to determine the next nonce based on a sequence number flip. When the first device is configured with one nonce, the first device may determine the first packet is associated with packet number x and sequence number s, even though the first packet includes a sequence number of s′. In this alternative configuration, the first device may align the packet counter of the first device with that of the second device by setting the packet counter to packet number x+1. Further, the first device may set the expected sequence number to s′. Thus, the first device may determine and/or generate a next first nonce to be used for decrypting the next packet based on the packet counter of x+1, and based on the expected sequence number of s′. Note that this third example may not occur when the first device is configured with one nonce, and the third example may not occur with a sequence flip when the first device is configured with two nonces.

For example, referring to FIG. 5, the decryption component 514 of the secondary device 504 may determine a next nonce to be used for decryption of a next received packet, such as one of the received packets 562b, 562c, 562d, 562e, based on the decryption of the one of the received packets 562a, 562b, 562c, 562d, and the decryption component 514 may determine that the next nonce is different when the one of the received packets 562a, 562b, 562c, 562d is unsuccessfully decrypted than when the one of the received packets 562a, 562b, 562c, 562d is successfully decrypted. For example, the decryption component 514 may determine a packet number and a sequence number corresponding to the one of the received packets 562a, 562b, 562c, 562d. The decryption component 514 may then determine a next packet number and a next sequence number expected to correspond to the next one of the received packets 562b, 562c, 562d, 562e. The decryption component 514 may set the packet counter 516 to a next expected packet number based on the packet number determined to correspond to the one of the received packets 562a, 562b, 562c, 562d. Further, the decryption component 514 may set the expected sequence number to a next expected sequence number based on the sequence number determined to correspond to the one of the received packets 562a, 562b, 562c, 562d. The decryption component 514 may then determine and/or generate the first nonce 520a to be used for decryption of the next one of the received packets 562b, 562c, 562d, 562e based on the packet counter 516 being set to the next expected packet number and the expected sequence number 518 being set to next expected sequence number. If the decryption component is configured with two nonces, the decryption component 514 may then determine and/or generate the second nonce 520b to be used for decryption of the next one of the received packets 562b, 562c, 562d, 562e based on the next consecutive increment of the packet counter that is set to the next expected packet number (for example, packet counter+1), and further based on the other sequence number different from the next expected sequence number, which may be s′ if the next expected sequence number is s or s if the next expected sequence number is s′. Various examples are illustrated with respect to FIG. 5 at Tables 1 through 4, supra.

In one aspect, operation 716 may include operation 740. At operation 740, the first device may determine a next expected sequence number based on a first expected sequence number included in the first packet. For example, the first device may determine the sequence number associated with the first packet, for example, based on whether the first packet is successfully or unsuccessfully decrypted. The first device may then determine the next expected sequence number, for example, based on whether the first packet is successfully or unsuccessfully decrypted. The first device may determine the next nonce further based on the determined next expected sequence number.

For example, referring to FIG. 5, the decryption component 514 of the secondary device 504 may determine a next expected sequence number based on the sequence number included in the one of the received packets 562a, 562b, 562c, 562d. The decryption component 514 may determine the sequence number included in the one of the received packets 562a, 562b, 562c, 562d, and then the decryption component 514 may set the expected sequence number 518 to the next expected sequence number based on the sequence number included in the one of the received packets 562a, 562b, 562c, 562d.

At operation 718, the first device may receive a second packet from the second device based on the passive monitoring of the short-range wireless communications link. For example, the first device may detect a packet over the short-range wireless communications link, and the first device may determine whether the detected packet is decodable by the first device.

For example, referring to FIG. 5, the secondary device 504 may receive a next one of the second packet 562b, the third packet 562c, the fourth packet 562d, or the fifth packet 562e of the set of packets 560. The secondary device 504 may detect a packet transmitted over the communications link 552, and the secondary device 504 may determine whether the packet is intended for the primary device 502, with which the secondary device 504 may be associated.

At operation 720, the first device may decrypt the second packet based on the determined next nonce. For example, if the first device is configured with one nonce, then the first device may decrypt the second packet using the next nonce. If the first device is configured with two nonces, the first device may determine to use the next nonce instead of a second next nonce based on a next expected sequence number associated with the next nonce. For example, the first device may detect a sequence number included in the second packet. The first device may compare the detected sequence number included in the second packet to the next expected sequence number associated with the next nonce. Further, the first device may compare the detected sequence number included in the first packet to a second next expected sequence number associated with the second next nonce. The first device may select the next nonce instead of the second next nonce when the detected sequence number included in the second packet matches the next expected sequence number associated with the next nonce. Otherwise, the first device may select the second next nonce that is associated with the next consecutive packet number following the next expected packet number to which the packet counter is set and associated with the other sequence number that is different from the next expected sequence number.

According to various aspects, the first device may generate the next nonce based on a decryption function that takes a set of inputs, and at least one of the inputs may be the next expected packet number to which the packet counter is set. Further, the decryption function may take the next expected sequence number as another of the set of inputs. The first device may load the next nonce into the memory to be used when applying the decryption function. The first device may then apply the decryption function to the second packet using the next nonce that is generated based on the next expected packet number and the next expected sequence number.

If configured with two nonces, the first device may further determine the second next nonce. For example, the first device may generate the second next nonce based on the aforementioned decryption function, although the at least one of the inputs may be consecutive to the next expected packet number of the packet counter, and another one of the inputs may be the other sequence number different from the next expected sequence number. As with the next nonce, the first device may load the second next nonce into the memory to be used when applying the decryption function. The first device may then determine whether to use the next nonce or the second next nonce based on whether the sequence number included in the second packet matches the next expected sequence number (associated with the next nonce) or matches the other sequence number different from the expected sequence number.

In various aspects, the first device may be configured to determine whether the second packet is successfully decrypted or unsuccessfully decrypted. Subsequently, the first device may be configured to then determine a next nonce to be used for decryption of a third received packet based on whether the second packet is successfully or unsuccessfully decrypted. Accordingly, the first device may return to operation 712 and iterate through the remaining operations of the method 700. For example, the first device may continue to iterate through the illustrated operations, which may begin with operation 712 and end with operation 722 before returning to operation 702, for each packet of a set of packets received from the second device based on the passive monitoring of the communications link.

For example, referring to FIG. 5, the decryption component 514 of the secondary device 504 may decrypt the next one of the received packets 562b, 562c, 562d, 562e using the next first nonce 520a or, if the decryption component 514 is configured with two nonces, using the determined one of the next first nonce 520a or the next second nonce 520b. For example, the decryption component 514 may generate the next first nonce 520a based on the next expected sequence number 518 and based on the next expected packet number to which the packet counter 516 is set. If the decryption component 514 is configured with two nonces, the decryption component 514 may generate the next second nonce 520b based on a different sequence number than the expected sequence number 518 and based on a packet number that is consecutive to the next expected packet number to which the packet counter 516 is set. Next, the decryption component 514 may apply a decryption function to the next one of the received packets 562b, 562c, 562d, 562e using the next first nonce 520a or, if the decryption component 514 is configured with two nonces, using the determined one of the next first nonce 520a or the next second nonce 520b. The decryption component 514 may obtain a decrypted next one of the received packets 562b, 562c, 562d, 562e based on applying the decryption function to the next one of the received packets 562b, 562c, 562d, 562e using the next first nonce 520a or, if applicable, using the next second nonce 520b. The decryption component 514 may identify a MIC included in the decrypted next one of the received packets 562b, 562c, 562d, 562e, and the MIC may be used to determine whether the decryption component 514 successfully decrypted the next one of the received packets 562b, 562c, 562d, 562e.

At operation 722, the first device may synchronize with a third device when the first device is unable to realign the packet counter of the first device with the packet counter of the second device. According to one aspect, if the first device is configured with one nonce, then the first device may be unable to realign the packet counter of the first device with the packet counter of the second device after the first device fails to detect more than three consecutive packets transmitted by the second device. According to one aspect, if the first device is configured with two nonces, then the first device may be unable to realign the packet counter of the first device with the packet counter of the second device after the first device fails to detect more than four consecutive packets transmitted by the second device.

The third device may be associated with the first device, and the first device may have another short-range communications link established with the third device. For example, the first device may be a secondary earpiece of a headset, and the third device may be a primary earpiece of the headset. In one aspect, the second device may have established the short-range wireless communications link that is passively monitored by the first device with the third device. According to one configuration, the first device may synchronize with the third device by receiving, over the other short-range communications link, information from the third device associated with a set of packets transmitted by the second device over the short-range wireless communications link. For example, the first device may receive a subset of the set of packets transmitted over the short-range wireless communications link—for example, the subset of the set of packets may include one or more packets that are not received or “missed” by the first device. In another example, the first device may receive information associated with a packet counter of the second device and/or third device. Based on the information received over the other short-range communications link, the first device may realign the packet counter of the first device with the packet counter of the second device. In addition, the first device potentially may change an expected sequence number to match the sequence number expected to be included in an expected packet to be received from the second device based on the information received over the other short-range communications link.

For example, referring to FIG. 5, the secondary device 504 may synchronize with the primary device 502 over the other short-range communications link 554, such as when the decryption component 514 is unable to realign the packet counter 516 with the packet counter of the source device 550. According to one aspect, if the decryption component 514 is configured with one nonce 520a, then the decryption component 514 may be unable to realign the packet counter 516 with the packet counter of the source device 550 after the secondary device 504 fails to detect more than three consecutive packets of the set of packets 560 transmitted by the source device 550. According to another aspect, if the decryption component 514 is configured with two nonces 520a, 520b, then the decryption component 514 may be unable to realign the packet counter 516 with the packet counter of the source device 550 after the secondary device 504 fails to detect more than four consecutive packets of the set of packets 560 transmitted by the source device 550.

For example, by synchronizing with the primary device 502, the secondary device 504 may receive one or more of next packets 562b, 562c, 562d, 562e, 562f of the set of packets 560, which may have not been received or “missed” by the secondary device 504 while passively monitoring the short-range wireless communications link 552. In another example, the secondary device 504 may synchronize with the primary device 502 by receive information associated with a packet counter of the primary device 502 and/or source device 550. Based on the information received over the other short-range communications link 554, the secondary device 504 may realign the packet counter 516 associated with the decryption component 514 of the secondary device 504 with the packet counter of the primary device 502 and/or the source device 550. In addition, the secondary device 504 potentially may change the expected sequence number 518 to match the sequence number expected to be included in an expected packet to be received from the source device 550 based on the information received over the other short-range communications link 554.

In various aspects, the first device may be configured to maintain the packet counter of the first device after synchronizing with the third device, and the first device may then continue to receive packets from the second device based on passively monitoring the short-range wireless communications link, and the first device may decrypt the received packets using a determined nonce. Accordingly, the first device may return to operation 704 and iterate through the remaining operations of the method 700. The first device may continue to iterate through the illustrated operations, which may begin with operation 702 and end with operation 722 before returning to operation 702, for each packet of a set of packets received from the second device based on the passive monitoring of the short-range wireless communications link.

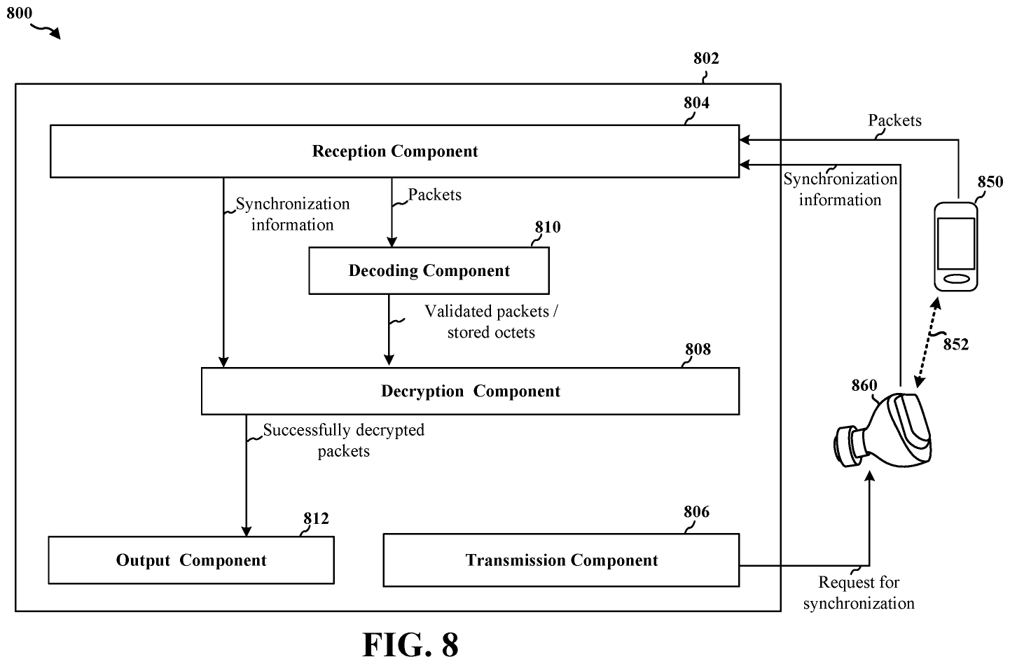

FIG. 8 is a conceptual data flow diagram 800 illustrating the data flow between different means/components in an exemplary apparatus 802. The apparatus may be a first device, such as a wireless device 102, a peripheral device 104, 106, 108, 110, 112, the secondary earpiece 114b, the wireless device 200, the secondary device 504).

The apparatus 802 may include a reception component 804 that may be configured to receive signals from a source device 850 and/or a primary device 860 on a short-range wireless communications link 852. For example, the reception component 804 may be configured to passively monitor the short-range wireless communications link 852 for packets transmitted by the source device 850. In some aspects, the apparatus 802 may include a transmission component 806 configured to transmit signals to the primary device 860, for example, the transmission component 806 may transmit a request for synchronization information to the primary device 860 over another communications link.

The apparatus 802 may further include a decryption component 808. The decryption component 808 may be configured to maintain a packet counter set to an expected packet number associated with a nonce for decryption of an expected packet. The decryption component 808 may consecutively increment the packet counter to an expected packet number based on each successfully decrypted packet received form the source device 850 over the short-range wireless communications link 852.

The reception component 804 may receive a first packet from the source device 850 based on the passive monitoring of the short-range wireless communications link 852. In various aspects, packets transmitted over the short-range wireless communications link 852 may be encrypted. For example, the first packet may be encrypted based on an AES-CCM mode.

The reception component 804 may provide the first packet to a decoding component 810. The decoding component 810 may determine whether the first packet passes CRC validation. For example, the decoding component 810 may generate a CRC value based on the first packet, and the decoding component 810 may compare the generated CRC value to a CRC value included in the first packet. If the generated CRC value matches the included CRC value, then the decoding component 810 may determine that the first packet passes CRC validation, and the decoding component 810 may provide the first packet to the decryption component 808. Otherwise, the decoding component 810 may discard the packet.

The decoding component 810 may be configured to store a set of octets corresponding to the CRC value included in each received packet. For example, the decoding component 810 may store a first set of octets corresponding to the CRC value included in the first packet. The first set of octets may correspond to at least one of the CRC value and/or the MIC included in the first packet.

The decryption component 808 may be configured to determine to use a first nonce instead of a second nonce for decryption of the first packet based on a first expected sequence number associated with the first nonce. In various aspects, the first expected sequence number may match a first sequence number included in the first packet, and the second nonce may be associated with a second expected packet number.

The decryption component 808 may decrypt the first packet using the first nonce, and the first nonce may be associated with a first expected packet number, which may be a current value of the packet counter. When the decryption component 808 decrypts the first packet, the decryption component 808 may validate a first MIC included in the first packet after the first packet is decrypted. The decryption component 808 may determine that the first packet is successfully decrypted when the first MIC is valid, and the decryption component 808 may determine that the first packet is unsuccessfully decrypted when the first MIC is invalid.

The decryption component 808 may then determine at least one next nonce based on the decryption of the first packet, and the at least one next nonce may be different when the first packet is successfully decrypted than when the first packet is unsuccessfully decrypted. For example, the at least one next nonce may be associated with a second expected packet number that is consecutive to the first expected packet number when the first packet is successfully decrypted, and the second expected packet number may be nonconsecutive to the first expected packet number when the first packet is unsuccessfully decrypted.

If the decryption component 808 successfully decrypts the first packet, the decryption component 808 may consecutively increment the packet counter and may change the expected sequence number. The decryption component 808 may provide the decrypted payload of the first packet to an output component 812. The output component 812 may include a codec configured to decode data and cause that data to be output, such as through a speaker of the output component 812.

In one configuration, when the first packet is unsuccessfully decrypted, the decryption component 808 may receive, from the decoding component 810, a stored set of octets associated with at least one of a previous CRC value or a previous MIC included in a previous packet that is associated with a previous packet number consecutively before the first expected packet number. The decryption component 808 may compare the first set of octets associated with the at least one of the first CRC value or first MIC included in the first packet with the stored set of octets. The decryption component 808 may determine the next nonce further based on comparing the first set of octets to the stored set of octets. For example, if the first set of octets matches the stored set of octets, then the decryption component 808 may determine that the first packet is a retransmission of the previous packet, and the decryption component 808 may refrain from incrementing a packet counter and/or changing an expected sequence number.

However, if the first set of octets does not match the stored set of octets when the first packet is unsuccessfully decrypted, then the decryption component 808 may determine a next expected packet number to which the packet counter of the decryption component 808 is to be set in order to realign the packet counter with a packet counter of the source device 850. Further, the decryption component 808 may determine a next expected sequence number for the next expected packet.

The decryption component 808 may generate at least the next nonce based on the packet counter and based on the next expected sequence number. If the decryption component 808 is configured with two nonces, the decryption component 808 may further generate a second next nonce based on the next consecutive packet number following the current packet counter and based on the other sequence number that is different from the next expected sequence number.

The reception component 804 may further receive a second packet from the source device 850 based on the passive monitoring of the short-range wireless communications link 552. If the second packet passes CRC validation by the decoding component 810, the decryption component 808 may decrypt the second packet based on the determined next nonce. For example, the decryption component 808 may select the next nonce or, if the decryption component 808 is configured with two nonces, the second next nonce based on a sequence number included in the second packet.

If the decryption component 808 is unable to realign the packet counter with that of the source device, the transmission component 806 may transmit a request for synchronization to the primary device 860. The primary device 860 may provide synchronization information to the apparatus 802. Such synchronization information may include a set of missed packets, packet counter information, etc. The decryption component 808 may use the synchronization information to realign the packet counter with that of the source device 850.

The apparatus may include additional components that perform each of the blocks of the algorithm in the aforementioned flowchart of FIGS. 6, 7A, and 7B. As such, each block in the aforementioned flowchart of FIGS. 6, 7A, and 7B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

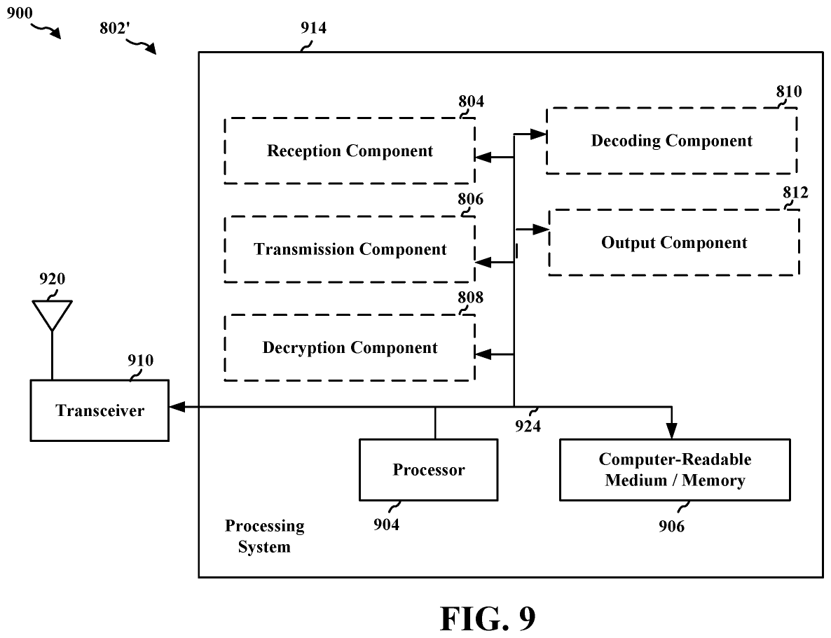

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 806, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812. The components may be software components running in the processor 904, resident/stored in the computer-readable medium/memory 906, one or more hardware components coupled to the processor 904, or some combination thereof.

In one configuration, the apparatus 802/802′ for wireless communication may include means for decrypting a first packet using a first nonce associated with a first expected packet number. The apparatus 802/802′ may include means for determining a next nonce based on the decrypting of the first packet, wherein the next nonce is different when the first packet is unsuccessfully decrypted than when the first packet is successfully decrypted. The apparatus 802/802′ may include means for decrypting a second packet received consecutive to the first packet based on the next nonce.

In one aspect, the next nonce is associated with a second expected packet number that is consecutive to the first expected packet number when the first packet is successfully decrypted and the second expected packet number is nonconsecutive to the first expected packet number when the first packet is unsuccessfully decrypted. In one aspect, the apparatus 802/802′ may include means for determining to use the first nonce instead of a second nonce based on a first expected sequence number associated with the first nonce, wherein the first expected sequence number matches a first sequence number included in the first packet, and wherein the second nonce is associated with a second expected packet number.

In one aspect, the means for determining the next nonce based on the decrypting of the first packet is configured to determine a next expected sequence number based on a first sequence number included in the first packet, wherein the next nonce is determined further based on the next expected sequence number.

In one aspect, the apparatus 802/802′ may be further configured to validate a first MIC included in the first packet after the first packet is decrypted, wherein the first packet is successfully decrypted when the first MIC is valid, and wherein the first packet is unsuccessfully decrypted when the first MIC is invalid.

In one aspect, the apparatus 802/802′ may include means for comparing, when the first packet is unsuccessfully decrypted, a first set of octets associated with at least one of a first CRC value or a first MIC included in the first packet with a stored set of octets associated with at least one of a previous CRC value or a previous MIC included in a previous packet that is associated with a previous packet number consecutively before the first expected packet number, wherein the determining the next nonce is further based on the comparing the first set of octets to the stored set of octets. In one aspect, the next nonce is associated with the first expected packet number when the first set of octets matches the stored set of octets.

The apparatus 802/802′ may further include means for passively monitoring a short-range wireless communications link for packets transmitted by a second device. The apparatus 802/802′ may further include means for receiving the first packet from the second device based on the passive monitoring of the short-range wireless communications link. The apparatus 802/802′ may further include means for receiving the second packet from the second device based on the passive monitoring of the short-range wireless communications link.

The apparatus 802/802′ may further include means for maintaining a packet counter set to an expected packet number associated with a nonce for decryption of an expected packet, wherein the packet counter is consecutively incremented to the expected packet number based on each successfully decrypted packet received from the second device over the short-range wireless communications link. In one aspect, the decryption of the first packet is based on an AES-CCM mode.

The aforementioned means may be one or more of the aforementioned processor(s) 202, short-range communications controller 252, and/or radio 230 in FIG. 2, components of the apparatus 802 and/or the processing system 914 of the apparatus 802′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of short-range wireless communications by a first device, comprising:
decrypting a first packet using a first nonce associated with a first expected packet number;
determining a next nonce based on the decrypting of the first packet, wherein the next nonce is different when the first packet is unsuccessfully decrypted than when the first packet is successfully decrypted; and
decrypting a second packet received consecutive to the first packet based on the next nonce.

2. The method of claim 1, wherein the next nonce is associated with a second expected packet number that is consecutive to the first expected packet number when the first packet is successfully decrypted and the second expected packet number is nonconsecutive to the first expected packet number when the first packet is unsuccessfully decrypted.

3. The method of claim 1, further comprising:
determining to use the first nonce instead of a second nonce based on a first expected sequence number associated with the first nonce, wherein the first expected sequence number matches a first sequence number included in the first packet, and wherein the second nonce is associated with a second expected packet number.

4. The method of claim 1, wherein the determining the next nonce based on the decrypting of the first packet comprises:
determining a next expected sequence number based on a first sequence number included in the first packet, wherein the next nonce is determined further based on the next expected sequence number.

5. The method of claim 1, further comprising:
validating a first message integrity code (MIC) included in the first packet after the first packet is decrypted, wherein the first packet is successfully decrypted when the first MIC is valid, and wherein the first packet is unsuccessfully decrypted when the first MIC is invalid.

6. The method of claim 1, further comprising:
comparing, when the first packet is unsuccessfully decrypted, a first set of octets associated with at least one of a first cyclic redundancy check (CRC) value or a first message integrity code (MIC) included in the first packet with a stored set of octets associated with at least one of a previous CRC value or a previous MIC included in a previous packet that is associated with a previous packet number consecutively before the first expected packet number,
wherein the determining the next nonce is further based on the comparing the first set of octets to the stored set of octets.

7. The method of claim 6, wherein the next nonce is associated with the first expected packet number when the first set of octets matches the stored set of octets.

8. The method of claim 1, further comprising:
passively monitoring a short-range wireless communications link for packets transmitted by a second device;
receiving the first packet from the second device based on the passive monitoring of the short-range wireless communications link; and
receiving the second packet from the second device based on the passive monitoring of the short-range wireless communications link.

9. The method of claim 8, further comprising:
maintaining a packet counter set to an expected packet number associated with a nonce for decryption of an expected packet, wherein the packet counter is consecutively incremented to the expected packet number based on each successfully decrypted packet received from the second device over the short-range wireless communications link.

10. The method of claim 1, wherein the decrypting of the first packet is based on an Advanced Encryption Standard (AES) with cipher block chaining message authentication code (CBC-MAC) (CCM) (AES-CCM) mode.

11. An apparatus for short-range wireless communications by a first device, comprising:
a memory; and
at least one processor coupled to the memory and configured to:
decrypt a first packet using a first nonce associated with a first expected packet number;
determine a next nonce based on the decryption of the first packet, wherein the next nonce is different when the first packet is unsuccessfully decrypted than when the first packet is successfully decrypted; and
decrypt a second packet received consecutive to the first packet based on the next nonce.

12. The apparatus of claim 11, wherein the next nonce is associated with a second expected packet number that is consecutive to the first expected packet number when the first packet is successfully decrypted and the second expected packet number is nonconsecutive to the first expected packet number when the first packet is unsuccessfully decrypted.

13. The apparatus of claim 11, wherein the at least one processor is further configured to:
determine to use the first nonce instead of a second nonce based on a first expected sequence number associated with the first nonce, wherein the first expected sequence number matches a first sequence number included in the first packet, and wherein the second nonce is associated with a second expected packet number.

14. The apparatus of claim 11, wherein the determination of the next nonce based on the decrypting of the first packet comprises to:
determine a next expected sequence number based on a first sequence number included in the first packet, wherein the next nonce is determined further based on the next expected sequence number.

15. The apparatus of claim 11, wherein the at least one processor is further configured to:
validate a first message integrity code (MIC) included in the first packet after the first packet is decrypted, wherein the first packet is successfully decrypted when the first MIC is valid, and wherein the first packet is unsuccessfully decrypted when the first MIC is invalid.

16. The apparatus of claim 11, wherein the at least one processor is further configured to:
compare, when the first packet is unsuccessfully decrypted, a first set of octets associated with a first cyclic redundancy check (CRC) value included in the first packet with a stored set of octets associated with a previous CRC value included in a previous packet that is associated with a previous packet number consecutively before the first expected packet number,
wherein the determination of the next nonce is further based on the comparison of the first set of octets to the stored set of octets.

17. The apparatus of claim 16, wherein the next nonce is associated with the first expected packet number when the first set of octets matches the stored set of octets.

18. The apparatus of claim 11, wherein the at least one processor is further configured to:
passively monitor a short-range wireless communications link for packets transmitted by a second device;
receive the first packet from the second device based on the passive monitoring of the short-range wireless communications link; and
receive the second packet from the second device based on the passive monitoring of the short-range wireless communications link.

19. The apparatus of claim 18, wherein the at least one processor is further configured to:
maintain a packet counter set to an expected packet number associated with a nonce for decryption of an expected packet, wherein the packet counter is consecutively incremented to the expected packet number based on each successfully decrypted packet received from the second device over the short-range wireless communications link.

20. The apparatus of claim 11, wherein the decryption of the first packet is based on an Advanced Encryption Standard (AES) with cipher block chaining message authentication code (CBC-MAC) (CCM) (AES-CCM) mode.

21. An apparatus for short-range wireless communications by a first device, comprising:
means for decrypting a first packet using a first nonce associated with a first expected packet number;
means for determining a next nonce based on the decrypting of the first packet, wherein the next nonce is different when the first packet is unsuccessfully decrypted than when the first packet is successfully decrypted; and
means for decrypting a second packet received consecutive to the first packet based on the next nonce.

22. The apparatus of claim 21, wherein the next nonce is associated with a second expected packet number that is consecutive to the first expected packet number when the first packet is successfully decrypted and the second expected packet number is nonconsecutive to the first expected packet number when the first packet is unsuccessfully decrypted.

23. The apparatus of claim 21, further comprising:
means for determining to use the first nonce instead of a second nonce based on a first expected sequence number associated with the first nonce, wherein the first expected sequence number matches a first sequence number included in the first packet, and wherein the second nonce is associated with a second expected packet number.

24. The apparatus of claim 21, wherein the means for determining the next nonce based on the decrypting of the first packet is configured to:
determine a next expected sequence number based on a first sequence number included in the first packet, wherein the next nonce is determined further based on the next expected sequence number.

25. The apparatus of claim 21, further comprising:
means for validating a first message integrity code (MIC) included in the first packet after the first packet is decrypted, wherein the first packet is successfully decrypted when the first MIC is valid, and wherein the first packet is unsuccessfully decrypted when the first MIC is invalid.

26. The apparatus of claim 21, further comprising:
means for comparing, when the first packet is unsuccessfully decrypted, a first set of octets associated with a first cyclic redundancy check (CRC) value included in the first packet with a stored set of octets associated with a previous CRC value included in a previous packet that is associated with a previous packet number consecutively before the first expected packet number,
wherein the determining the next nonce is further based on the comparing the first set of octets to the stored set of octets.

27. The apparatus of claim 26, wherein the next nonce is associated with the first expected packet number when the first set of octets matches the stored set of octets.

28. The apparatus of claim 21, further comprising:
means for passively monitoring a short-range wireless communications link for packets transmitted by a second device;
means for receiving the first packet from the second device based on the passive monitoring of the short-range wireless communications link; and
means for receiving the second packet from the second device based on the passive monitoring of the short-range wireless communications link.

29. The apparatus of claim 28, further comprising:
means for maintaining a packet counter set to an expected packet number associated with a nonce for decryption of an expected packet, wherein the packet counter is consecutively incremented to the expected packet number based on each successfully decrypted packet received from the second device over the short-range wireless communications link.

30. A computer-readable medium storing computer-executable code for wireless communication by a first device, comprising code to:
decrypt a first packet using a first nonce associated with a first expected packet number;
determine a next nonce based on the decryption of the first packet, wherein the next nonce is different when the first packet is unsuccessfully decrypted than when the first packet is successfully decrypted; and
decrypt a second packet received consecutive to the first packet based on the next nonce.
